(19) United States
(12) Patent Application Publication
(10) Pub. No.: US 2011/0294960 A1
(43) Pub. Date: Dec. 1, 2011

(54) POLYLACTIDE COPOLYMERS

(75) Inventors: Marc A. Hillmyer, Minneapolis, MN (US); Grayce C. Theryo, St. Paul, MN (US); Louis M. Pitet, Cody, WY (US); Feng Jing, Snellville, GA (US)

(73) Assignee: Regents of the University of Minnesota, St. Paul, MN (US)

(21) Appl. No.: 13/115,796

(22) Filed: May 25, 2011

Related U.S. Application Data
(60) Provisional application No. 61/348,008, filed on May 25, 2010.

(51) Int. Cl. C08F 279/00

(52) U.S. Cl. 525/331.9

(57) ABSTRACT

A polylactide copolymer comprises a graft copolymer of a hydrophobic backbone polymer having a plurality of pendant hydroxyl groups and lactide. In one example, a polylactide includes a graft copolymer of a poly(1,5-cyclooctadiene-co5-norbornene-2-methanol) copolymer and lactide. A method of preparing a toughened polylactide comprises forming a hydrophobic backbone copolymer having a plurality of pendant hydroxyl groups and forming a polylactide graft copolymer by reacting the hydrophobic backbone copolymer having a plurality of pendant hydroxyl groups with lactide, wherein polymerized lactide stems from at least one of the plurality of pendant hydroxyl groups. In one example, a method comprises forming poly(1,5-cyclooctadiene-co-5-norbornene-2-menthanol) by reacting 1,5-cyclooctadiene and 5-norbornene-2-methanol in the presence of a 2^{nd} generation Grubbs' catalyst and cis-1,4-diacetoxy-2-butene as a chain transfer agent and forming poly(1,5-cyclooctadiene-co-5-norbornene-2-methanol-graft-lactide) by reacting the poly(1,5-cyclooctadiene-co-5-norbornene-2-menthanol) as a macroinitiator with lactide in the presence of tin 2-ethylhexanoate and toluene or in the presence of 1,5,7-triazabicyclo[4.4.0]dec-5-ene and dichloromethane.

This application claims the benefit of U.S. Provisional Application Ser. No. 61/348,008, filed May 25, 2010. The entire content of this application is incorporated herein by reference.

### TECHNICAL FIELD

The disclosure relates to polylactide polymers, which in certain examples have improved tensile toughness.

### BACKGROUND

Polylactide (PLA) is a renewable resource polymer made from a feedstock of animal feed grade corn. In addition to renewability, PLA is biocompatible and hydrolytically degradable and biodegradable. PLA products may be industrially composted within a reasonable time scale. In addition, PLA is a desirable polymer for use in biomedical applications because it is biocompatible with benign degradation products.

Despite its promise, PLA has a low glass transition temperature and an inherent lack of ductility, resulting in low impact strength and low tensile toughness. Therefore, polylactide homopolymers can be inadequate for impact-resistant applications. Thus, its application has primarily been limited to resorbable medical sutures, disposable food packaging and textile fiber.

Many methods of increasing PLA toughness have been attempted including homopolymer modification, copolymerization, and blending with both organic and inorganic components.

### SUMMARY

In general, the present disclosure relates to polylactide copolymers and methods for making them.

This disclosure is directed to a polylactide copolymer comprising a graft copolymer of a hydrophobic backbone polymer having a plurality of pendant hydroxyl groups and lactide. In one example, the disclosure is directed to a graft copolymer of a poly(1,5-cyclooctadiene-co-5-norbornene-2-methanol) copolymer and lactide.

The disclosure is also directed to a method of preparing a toughened polylactide, the method comprising forming a hydrophobic backbone copolymer having a plurality of pendant hydroxyl groups, and forming a polylactide graft copolymer by reacting the hydrophobic backbone copolymer having a plurality of pendant hydroxyl groups with lactide, wherein polymerized lactide stems from at least one of the plurality of pendant hydroxyl groups. In one example, the method comprises forming poly(1,5-cyclooctadiene-co-5-norbornene-2-menthanol) by reacting 1,5-cyclooctadiene and 5-norbornene-2-methanol in the presence of the 2^{nd} Generation Grubbs' catalyst and cis-1,4-diacetoxy-2-butene as a chain transfer agent, and forming poly(1,5-cyclooctadiene-co-5-norbornene-2-methanol-graft-lactide) by reacting the poly(1,5-cyclooctadiene-co-5-norbornene-2-methanol) as a macroinitiator with lactide in the presence of tin 2-ethylhexanoate and toluene or in the presence of 1,5,7-triazabicyclo[4.4.0]dec-5-ene and dichloromethane.

In one examples, the disclosure is directed to a composition comprising at least one of the polylactide copolymers described herein. In some examples, the composition may also include one or more polylactide homopolymers.

The details of one or more examples of the disclosure are set forth in the accompanying drawings and the description below. Other features, objects, and advantages of the disclosure will be apparent from the description and from the claims.

### BRIEF DESCRIPTION OF DRAWINGS

FIG. 1 shows a ¹H NMR spectrum, key resonances, and peak assignments of an example backbone macroinitiator for use in a toughened polylactide graft copolymer of Example 1.

FIG. 2 shows a ¹H NMR spectrum, key resonances, and peak assignments of the toughened polylactide graft copolymer of Example 1.

FIG. 3 shows size exclusion chromatography data of the toughened polylactide graft copolymer of Example 1.

FIG. 4 shows a ¹H NMR spectrum of a low molecular weight fraction of an example toughened polylactide graft copolymer of Example 1.

FIG. 5 shows a ¹H NMR spectrum, key resonances, and peak assignments for the polylactide homopolymer control of Comparative Example 1.

FIG. 6 shows the size exclusion chromatography data of the polylactide homopolymer control of Comparative Example 1.

FIG. 7 shows stress-strain data for samples of toughened polylactide graft copolymers of Example 1.

FIG. 8 shows the stress-strain data for a small strain limit for the samples of toughened polylactide graft copolymers of Example 1.

FIG. 9 shows small-angle x-ray scattering data of a sample of toughened polylactide graft copolymers of Example 1.

FIG. 10 shows additional small-angle x-ray scattering of a sample of toughened polylactide graft copolymer of Example 1.

FIG. 11 shows a comparison of ¹H NMR signals from PLA initiation sites along a backbone macroinitiator and terminating end groups of Example 2.

FIG. 12 shows size exclusion chromatography data for an example backbone macroinitiator and an example toughened polylactide graft copolymer of Example 2, and an example polylactide homopolymer control of Comparative Example 2.

FIG. 13 shows samples of toughened polylactide graft copolymer of Example 2 and a sample polylactide homopolymer control of Comparative Example 2 before and after tensile testing.

FIG. 14 shows engineering stress-strain curves of the sample toughened polylactide graft copolymer of Example 2 and the sample polylactide homopolymer control of Comparative Example 2.

FIG. 15 shows differential scanning calorimetry data of an example backbone macroinitiator and an example toughened polylactide graft copolymer of Example 2 and a polylactide homopolymer control of Comparative Example 2.

FIG. 16 shows small-angle x-ray scattering data for the toughened polylactide graft copolymer of Example 2.

FIG. 17 shows transmission electron microscopy of thin sections of the toughened polylactide graft copolymer of Example 2.

FIG. 18 is a plot of the average TT as a function of backbone molecular weight between graft points or M_{n,eff} for various 95 wt % PLA polymers examples.

FIG. 19 is a schematic of a tensile bar defining the conventions used in both SAXS and TEM analysis in Example 3.

FIG. 20 illustrates the general characteristics of the 1D-scattering profiles for various examples compositions (89, 95 and 99 wt % PLA) with three graft copolymers synthesized from the same macroinitiator.

FIGS. 21a and 21b are the 2D SAXS patterns for a brittle 95 wt % graft copolymer example before deformation and after deformation, respectively.

FIGS. 22a and 22b are the 2D SAXS patterns for a ductile 95 wt % graft copolymer example before deformation and after deformation, respectively.

FIGS. 23a and 23b are TEM micrographs of the ductile 95 wt % PLA graft copolymer sample in the xy-plane and yz-plane, respectively.

FIGS. 24a and 24b are TEM micrographs of the cold-drawn gage region of the ductile 95 wt % PLA graft copolymer example in the xy-plane and yz-plane, respectively.

FIG. 25 is a TEM micrograph of the stress-whitened (not cold drawn) region of the ductile 95 wt % PLA graft copolymer example in the yz-plane.

### DETAILED DESCRIPTION

The present disclosure describes graft polymerization techniques that can be used to modify the mechanical properties of PLA copolymers, as well as the graft copolymers resulting from these copolymerization procedures. In some examples, the graft polymerization provides ordinarily brittle polylactide with more toughened characteristics. The resulting graft copolymers can have improved properties such as, for example, increased ductility and tensile toughness.

A toughened polylactide graft copolymer comprises a hydrophobic backbone polymer having a plurality of pendant hydroxyl groups with lactide grafted onto the backbone at the pendant hydroxyl groups, wherein polymerized lactide stems from at least one of the pendant hydroxyl groups. In one example, the hydrophobic backbone polymer comprises poly(1,5-cyclooctadiene-co-5-norbornene-2-methanol) (“PCN”). In another example, the hydrophobic backbone polymer comprises at least one of a hydroxylated polyisoprene backbone, a hydroxylated polybutadiene backbone, a hydroxylated polyethylene backbone, a hydroxylated polypropylene backbone, or a hydroxylated polyisobutylene backbone.

In some examples, the polyactide graft copolymer may also include a derivative of a hydrophobic backbone polymer having a plurality of pendant hydroxyl groups with lactide grafted onto the backbone at pendant groups. For example, the derivative may include ester derivatives of a hydrophobic backbone polymer having a plurality of pendant hydroxyl groups. In one example, the backbone polymer may include poly(ethylene-co-vinyl acetate), which is a derivative of poly(ethylene-co-vinyl alcohol). Other derivatives are contemplated.

In one example, a polylactide of the present disclosure is a graft copolymer of poly(1,5-cyclooctadiene-co-5-norbornene-2-methanol) (“PCN”), and lactide, such as D,L-lactide, named poly(1,5-cyclooctadiene-co-5-norbornene-2-methanol-graft-lactide) (“PCNL”), with the general formula shown in Formula 1.

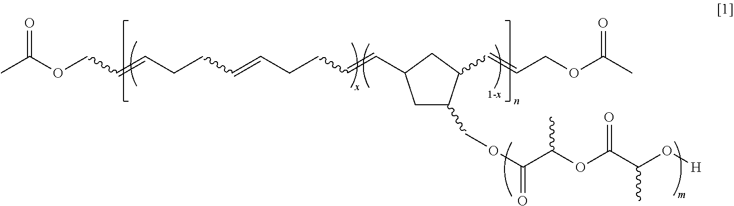

In one example, the average degree of polymerization (DP) of the PLA grafts is between about 40 and about 700, such as between about 70 and about 600, for example between about 95 and about 450. In one example, the number-average molecular weight of PCNL is between about 300 and about 1000 kg per mole, such as between about 300 and about 750 kg per mole. In one example, between about 65 wt % and about 99 wt % of the copolymer comprises the polylactide grafts, such as between about 80 wt % and about 99 wt %. In one example, the PCNL has a polydispersity index (“PDI”) between about 2 and about 2.8. In one example, PCNL has between about 1 wt % and about 20 wt % homopolymer PLA formed by adventitious initiation, but would preferably contain less than about 10 wt % homopolymer PLA, such as less than about 5 wt % homopolymer PLA, and most preferably about 0 wt % homopolymer PLA.

The PCNL of the present disclosure is synthesized by first forming PCN by copolymerizing 1,5-cyclooctadiene (“C”) with 5-norbornene-2-methanol (“N”) by ring-opening metathesis polymerization (“ROMP”) in the presence of the 2^{nd} Generation Grubbs' catalyst (“G2”) and cis-1,4-diacetoxy-2-butene as a chain transfer agent, as shown in Equation 2.

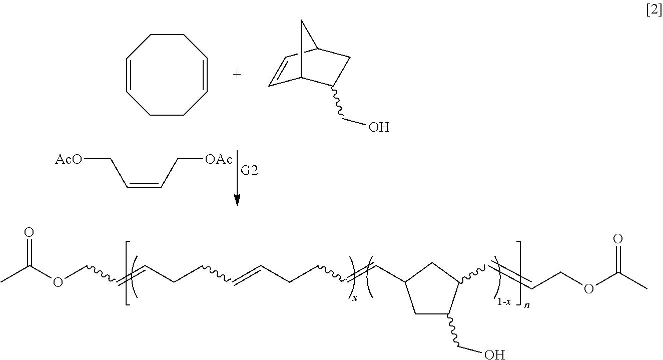

The pendant hydroxyl functionality on the norbornene comonomer is used to initiate the polymerization of PLA and serves as the graft junction point so that PCN acts as a macroinitiator for the formation of PCNL. The degree of polymerization of the PCN polymer is controlled by the ratio of the monomers (C and N) to the chain transfer agent. In one example, the average degree of polymerization for C was between about 100 and about 500, such as between about 150 and about 350, for example about 166. In one example, the number average degree of polymerization of C in the PCN backbone is between about 200 and about 350, such as about 332. The average number of graft junction points per chain and spacing between the graft junction points may be controlled through the comonomer ratio (e.g., the ratio of C to N) and the concentration of the chain transfer agent. In one example, about 3 mol % N was included in the feed, which with a target degree of polymerization of about 200 theoretically should yield about 6 junction points per chain. In one example, between about 0.3 mol % N and about 30 mol % N is present in the feed. In one example, the PCN polymer has between about 2 and about 40 junction points per chain, such as between about 4 and about 11 junction points per chain, for example about 5.5 junction points per chain and in another example about 10.9 junction points per chain. In one example, the molar ratio of C to G2 catalyst is between about 2000:1 and 20, 000:1, such as about 20,000:1. In one example, the resulting PCN polymer has a low glass transition temperature of about −80° C. In another example, the pendant primary hydroxyl groups that act as graft points for the ROP of lactide (described below) are statistically distributed throughout the PCN polymer.

Next, lactide is grafted onto the PCN macroinitiator in the presence of a catalyst to form PCNL, as shown in Equation 3.

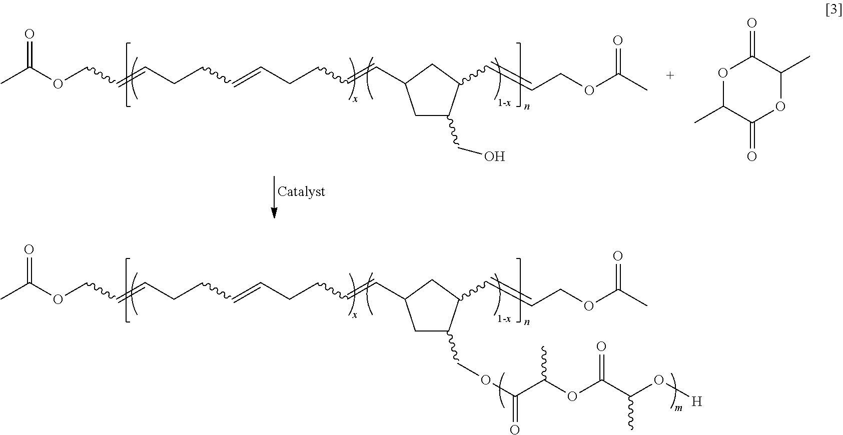

The PCN acts as a macroinitiator for a ring-opening polymerization (ROP) reaction of the lactide. In one example, the lactide comprises L-lactide. In another example, the lactide comprises D-lactide. In another example, the lactide comprises D,L-lactide (an approximately 50/50 mixture of L-lactide and D-lactide). In another example, the lactide comprises meso-lactide. In some examples, the lactide may be some combination of lactides such as, some combination of two or more of D,L-lactide, L-lactide, meso-lactide, and D-lactide, or may consist essentially of any suitable lactide, including those examples describe herein, individually or in combination with each other. In one example, the lactide may include primarily L-lactide with some dosage of D-lactide, meso-lactide and/or D,L-lactide (e.g., approximately 15 wt % D-lactide, meso-lactide and/or D,L-lactide). In some examples, the concentration of D-lactide, meso-lactide and/or D,L-lactide in L-lactide may be between zero and 50 wt %. However, other examples are contemplated.

In one example, the catalyst of Equation 3 comprises at least one of 1,5,7-triazabicyclo[4.4.0]dec-5-ene (“TBD”) in the presence of dichloromethane or tin (II) ethylhexanoate (“Sn(Oct)₂”) in the presence of toluene. In one example, the degree of polymerization (DP) of the polylactide grafts is between about 40 and about 700, such as between about 200 and about 500, for example between about 300 and about 400. In one example, the theoretical molecular weight of each polylactide graft chain is about 65 kg per mole. Analysis using ¹H NMR (proton nuclear magnetic resonance) signals from the PLA initiation sites along the PCN backbone and the terminating end groups (described in more detail below) of one example PCNL polymer suggests that the graft copolymer may contain a small portion of PLA homopolymer from adventitious initiation. If it is assumed the molar masses of the free chain homopolymers and the grafted PLA chains are equal, then in one example the calculated weight percentage of the PLA homopolymer is about 18 wt %. Based on the molar mass of the PCN backbone, the estimated PLA chain length for each graft, and the average number of grafts per backbone, in one example the estimated number-average molecular weight of the PCNL polymer is between about 400 and about 700 kg per mole, such as between about 500 and about 600 kg per mole, for example about 659 kg per mole. In one example, between about 80 wt % and about 99 wt % of the copolymer comprises the polylactide, such as between about 90 wt % and about 97 wt %, for example about 95 wt %. In one example, the PCNL has a polydispersity index (PDI) of between about 2 and about 2.8.

The toughened PCNL described above is potentially useful in applications requiring some impact strength. Moreover, the PCNL described is a polymer made from monomer units the majority of which are available from renewable feedstock. As described above, the lactide in PCNL can be developed from animal feed grade corn.

Block copolymerization introduces an additional number of variables including: number of distinct monomers, number of blocks (AB diblock, ABA triblock, etc.), block sequence (e.g. ABA vs. BAB), block architecture (e.g. grafted or star blocks) and molecular weight of each block. In addition, block copolymers can spontaneously self-assemble into well-ordered microphase morphologies analogous to the development of microstructure and phases in metallic alloys. Each phase or domain in the morphology is rich in one of the chemically distinct blocks. Several equilibrium morphologies have been observed for AB diblock copolymers including a spherical phase, cylindrical phase, gyroid phase, and lamellar phase. The spherical phase consists of spheres of the minority block in a body-centered cubic arrangement within a matrix of the majority block. In the cylindrical phase, the minority block is found in hexagonally close packed cylinders in a matrix of the majority block. The gyroid phase is a more complex morphology consisting of bicontinuous triply periodic saddles surfaces. Finally, the lamellar phase consists of alternating layers, or lamellae, of each block.

The well-ordered, phase-separated morphologies result from the minimization of free energy through the competition of two thermodynamic quantities: enthalpy of mixing and conformational entropy. The enthalpy of mixing or interfacial tension between the two monomers is proportional to their segment-segment interaction parameter, χχ. A positive value for χ implies that chemically distinct monomers will not favor mixing and will prefer to separate. The segment-segment interaction parameter is also inversely proportional to temperature, resulting in an Order-Disorder Transition (ODT) temperature above which the blocks are miscible. As the temperature of the system decreases, χ will increase and phase separation is favored.

The self-assembly process is also influenced by kinetics. If the equilibrium morphologies are allowed to develop, they can then be trapped in the solid as the material cools below its glass transition temperature. With a covalent bond adjoining the chemically distinct polymers, at best, each block can adopt an extended linear conformation to avoid mixing, but still cannot separate on a macroscopic scale. However, there is an entropic penalty for stretching fully instead of adopting an unperturbed coil conformation, which opposes the enthalpic immiscibility. The entropic contribution to the free energy of mixing is inversely proportional to the degree of polymerization, N. As a result, the net driving force for separation increases as the size of the molecules increase. Even blocks with lower values of χ (more compatible) may phase separate if the degree of polymerization is large enough. Thus, the product χN is the quantity that embodies the overall degree of segregation for the block copolymer system. The phase behavior of block copolymers can be subdivided into three categories: the strong-segregation limit where χN>100, the weak segregation limit for χN˜10 and the intermediate segregation limit between the two. The specific morphology formed is also a function of the composition of the copolymer parameterized by volume fraction of one of the components (for a two component system), fᵢ.

The morphology of block copolymers strongly influences mechanical properties. For example, for a constant composition of polystyrene (ca. 70 vol %), it has been shown that a morphology of polybutadiene cylinders in a matrix of polystyrene exhibited only a small amount of plastic deformation while a lamellar morphology was clearly ductile. Additionally, cylinders of polystyrene in a matrix of polybutadiene (containing a majority of polybutadiene) exhibited behavior typically seen for thermoplastic elastomers. With these considerations, cylindrical and lamellar morphologies are preferred. The gyroid morphology is not preferred due to the small composition window. The ductility observed for lamellar morphologies is appealing, however, a cylindrical morphology will allow for a higher level of the grafted component.

In order to predict whether or not microphase separation should be expected for the PCNL graft copolymer described above with respect to Equations 1-3, the segment-segment interaction parameter between PCN and PLA must be determined. The majority of PCN is structurally identical to poly(1,4-butadiene) so the comparison will be made between polylactide and poly(1,4-butadiene). As this has not been done experimentally, χ_{eff} can be estimated relative to a previously determined χ_{eff} by examining the ratio of the difference in solubility parameters calculated from group contributions. The χ_{eff} between polystyrene and polylactide has been experimentally determined to be 0.126 at 140° C. Table 1 lists the solubility parameters used to estimate χ_{eff} between polybutadiene and polylactide relative to polystyrene and polylactide.

TABLE 1
Solubility Parameters Used to Estimate χ_{eff} between Polylactide
and Polybutadiene Relative to Polylactide-Polystyrene

| | Polylactide | Polystyrene | Polybutadiene |
|---|---|---|---|
| Solubility parameter | 19.7 | 18.6 | 8.4 |
| (J^{1/2}cm^{2/3}) | | | |

The difference in solubility parameters between polylactide and polybutadiene is larger than the difference between polylactide and polystyrene. Therefore, the χ_{eff} between polylactide and polybutadiene is expected to be approximately two times larger, resulting in χ_{eff,PLA-PB}≅0.29. As the relevant product χN for a graft copolymer is that of its constituting block copolymer, N is determined to be approximately 400 (assuming a regular spaced graft copolymer) which gives χN=121. Thus, microphase separation should be expected given that the degree of segregation for the graft copolymer is in the strong segregation limit. Based upon transmission electron microscopy (“TEM”), with the backbone of the polymer stained, it was concluded the material was microphase separated, but not well ordered. The domain spacing observed by TEM was found to agree with the domain spacing determined by small-angle x-ray scattering (SAXS). Thus, it is highly likely that the graft copolymer after compression molding was microphase separated, but not well-ordered as supported by direct SAXS measurements, theoretical predictions and indirect comparisons to a similar material.

Some examples of the present disclosure will be further described by way of the following Examples. However, the present disclosure is not limited thereto, and examples other than that described are contemplated.

### EXAMPLES

### Example 1

### Materials

ACS reagent grade starting materials and solvents were used as received from commercial suppliers without further purification with exception to the following. Degassed toluene was purified by a custom-made solvent purification line equipped with an activated alumina catalyst and a supported copper catalyst. D,L-lactide (Purac) was recrystallized from toluene, dried under vacuum at room temperature for >12 hours and stored under nitrogen. Tin(II) ethylhexanoate, abbreviated Sn(Oct)₂, was purified by distillation and stored under nitrogen.

### Synthesis of Poly(1,5-cyclooctadiene-co-5-Norbornene-2-methanol-graft-Lactide)

To a warm 500 mL round bottom flask charged with a magnetic stir bar, 2.50 g (2.07 μmol) of poly(1,5-cyclooctadiene-co-5-norbornene-2-methanol) was added. In a dry box, 175 mL of toluene was added to the flask and allowed to stir for 1 hour at room temperature. After dissolution of the macroinitiator, D,L-lactide (50.0 g, 0.35 mol) and Sn(Oct)₂ (30 mg, 74 μmol dissolved in 8 mL dry toluene) were added to the flask. The flask was sealed with a rubber septum. Upon removal from the dry box, the flask was placed in a 100° C. thermostatted oil bath for 5 hours. Initially, the solution was clear, colorless and stirring easily. After 5 hours, the solution remained clear and colorless, but an increase in viscosity was visually observed. The flask was removed from heat and 250 mL of toluene was added to reduce the viscosity. The polymer precipitated out as white fibrous solids into ˜4 L of methanol at room temperature. The solids were collected by filtration and subsequently re-dissolved into 400 mL of tetrahydrofuran (THF). The polymer was precipitated into cold methanol in the form of white, stringy solids. The polymer was dried in a vacuum oven at 90° C. for 3 days and proven free of solvent by ¹H NMR.

### Comparative Example 1

Homopolymer polylactide was synthesized as shown in Equation 4 to create a control polymer for comparison.

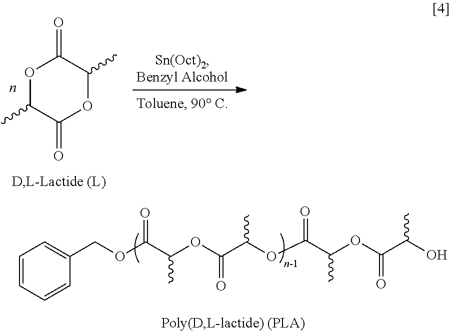

The synthesis of poly(D,L-lactide) was accomplished via the following method. In a dry box, D,L-lactide (58.82 g, 0.41 mol) was added to a 500 mL round-bottom flask equipped with stir bar. Sn(Oct)₂ (33.1 mg) was dissolved in dry toluene (2 mL). Benzyl alcohol (88.2 mg) from Aldrich was dissolved in dry toluene (2 mL). Dry toluene (200 mL), initiator and catalyst solutions were added to the flask respectively. The flask was sealed with a rubber septum and removed from the dry box. The flask was placed in a thermostatted oil bath set to 100° C. for approximately 3 hours. A sample of the crude reaction solution was removed for ¹H NMR analysis. The flask was removed from the oil bath and 200 mL of toluene was added. The polymer was precipitated into 4 L of methanol. The solid was collected by filtration through a Buchner funnel. The collected polymer was re-dissolved in THF and precipitated into cold methanol. After filtering, the polymer was dried in a vacuum oven at 90° C. for two days. The absence of residual solvent after drying was confirmed by ¹H NMR.

### General Procedures of Example 1 and Comparative Example 1

Proton Nuclear Magnetic Spectroscopy (¹H NMR) was performed on a Varian Inova 500 spectrometer at 500 MHz at room temperature. Chemical shifts are reported in ppm with respect to the residual proton signals in the solvent. Samples were dissolved in deuterated-chloroform (Cambridge) to concentrations of ˜20 mg/mL with subsequent filtering through glass wool to remove dust.

Size-exclusion chromatography was performed at 35° C. on a Hewlett-Packard 1100 series liquid chromatograph equipped with three Plgel 5 μm Mixed-C columns in series and a Hewlett-Packard 1047A differential refractometer. Chloroform was used as the mobile phase with an elution rate of 1 mL/min. Samples were prepared by dissolving 1 to 2 mg of polymer in chloroform and filtering the solution through a 0.2 μm Teflon filter. Polystyrene standards (Polymer Laboratories) were used for calibration of molecular weights. Differential scanning calorimetry was performed on a TA DSC Q1000 utilizing an indium standard for temperature calibration. At least 4 mg of sample were analyzed in a nitrogen environment with a 10° C./min heating rate. Glass transition temperatures were determined from the second heating after annealing above the glass transition for 5 seconds to erase thermal history.

Solvent-nonsolvent fraction was performed by dissolving 1 gram of polymer in 10 mL of acetone in a beaker. 10 mL of methanol was added slowly with stirring. The mixture was cooled to 20° C. for 45 minutes to allow separation. The top layer was decanted off and both layers were examined by size exclusion chromatography (“SEC”). The high molecular weight fraction was fractionated again using the same procedure. Both layers were examined by SEC. Only the low molecular weight fraction was analyzed with ¹H NMR.

### Results of Example 1 and Comparative Example 1

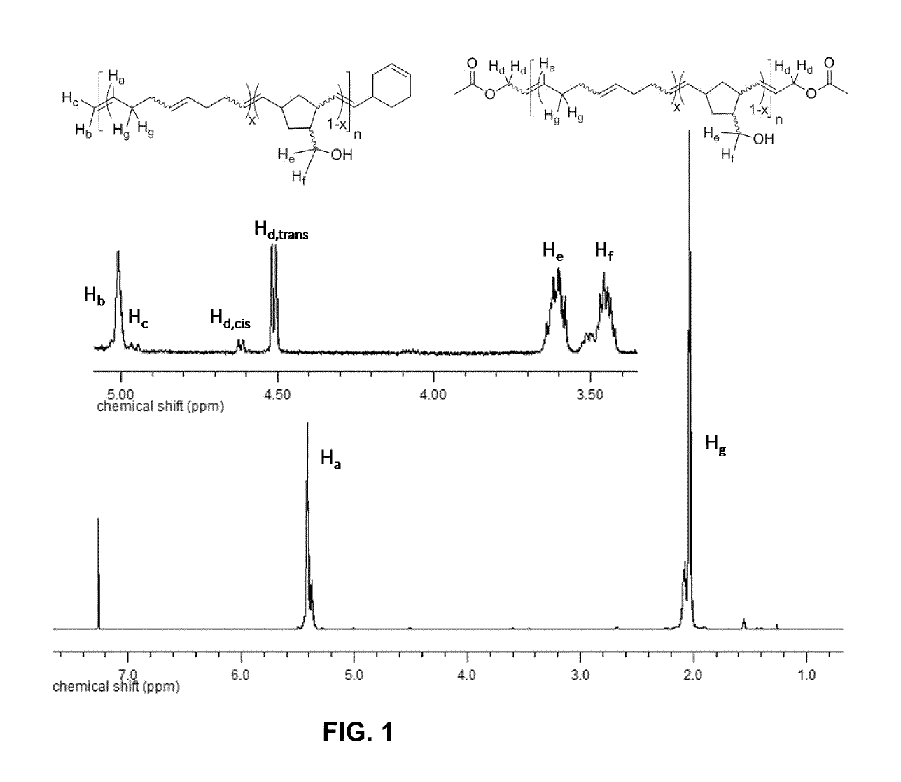

The PCN macroinitiator used to synthesize the PCNL graft copolymer of Example 1 was characterized by ¹H NMR, SEC and DSC. The full ¹H NMR spectrum of PCN macroinitiator can be seen in FIG. 1 with the key resonances and peak assignments identified. The 1,5-cyclooctadiene monomer contained a small amount of vinyl cyclohexene (VCH) isomer which acted as an adventitious chain transfer agent. Thus, the molecular weight of the PCN macroinitiator is dependent on both the concentration of VCH and the added chain transfer agent, cis-2-butene-1,4-diol diacetate (DAB). The degree of polymerization of COD was calculated by using the integrations of the ¹H NMR signals (FIG. 1) from the olefinic protons (Hₐ, normalized), one of the two methylene protons of the VCH endgroup (H_{c}), and the methylene protons of the DAB end group (H_{d, trans} and H_{d, cis}, normalized). Additionally, the amount of 5-norbornene-2-methanol comonomer incorporated is found from the ratio of the integrals of the peaks corresponding to the methylene protons adjacent to the hydroxyl group (Hₑ or H_{f}) to the poly(1,5-cyclooctadiene) backbone methylene protons normalized to one repeat unit (Hₐ/4). The average number of 1,5-cyclooctadiened units per chain in the macroinitiator was found to be 166 while the average number of norbornene methanol units was found to be 5.5 per macroinitiator chain. The SEC trace shows a monomodal distribution with a PDI of 1.8. Analysis by DSC reveals a small melting endotherm at 24° C. and a glass transition at −89° C. Utilizing PCN as a macroinitiator, poly(1,5-cyclooctadiene-co-5-norbornene-2-methanol-graft-lactide) (“PCNL”) of Example 1 was synthesized as described above.

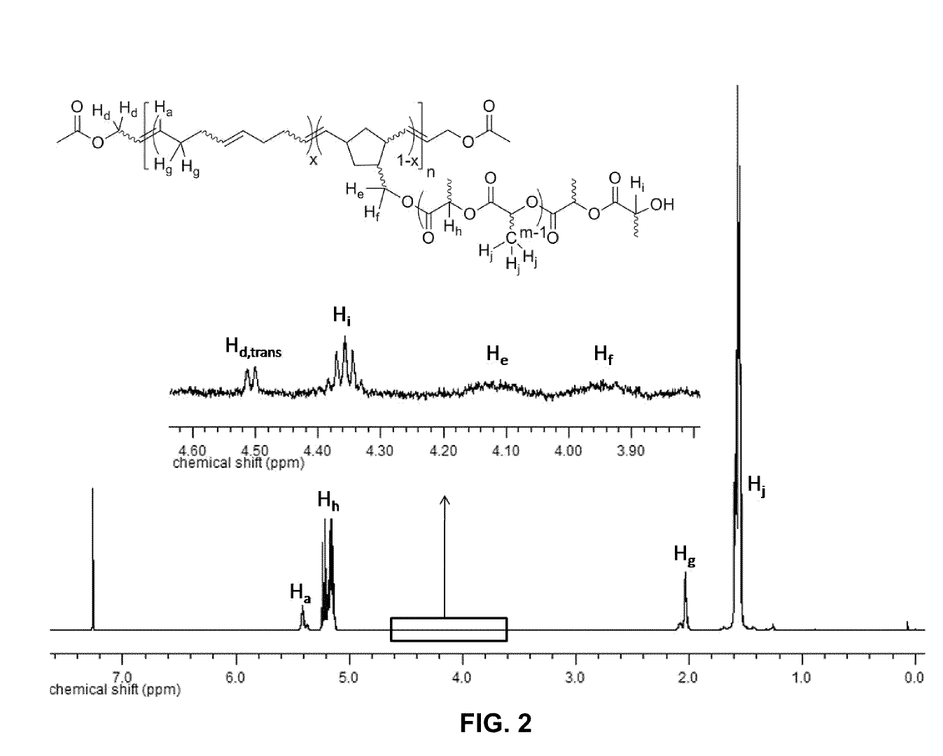

The theoretical degree of polymerization of lactide per graft in PCNL of Example 1 was 446 with a lactide to catalyst molar ratio of 5000:1. The composition of the monomer feed was 95 wt % D,L-lactide and 5 wt % PCN macroinitiator The isolated yield was 92% on a 52 gram scale. As before, the polymer was characterized with ¹H NMR, SEC and DSC. The full ¹H NMR spectrum of PCNL of Example 1 can be seen in FIG. 2 with the key resonances and peak assignments identified. As a result of the ROP of lactide initiated by the pendant hydroxyl group, the resonances for the methylene protons adjacent to oxygen (Hₑ and H_{f}) are shifted downfield. The ratio of the integrals of the methylene protons (Hₑ or H_{f}) to the methine proton of the PLA end group (Hᵢ) should theoretically be 1:1. However, the analysis reveals the ratio of Hₑ to Hᵢ to be approximately 0.6:1 indicating that the number of PLA end groups is larger than expected and that adventitious initiation may have occurred. The adventitious initiation of lactide ring-opening can be further minimized in this reaction. The processing and polymerization conditions are easily modified to optimize the resultant polymer characteristics.

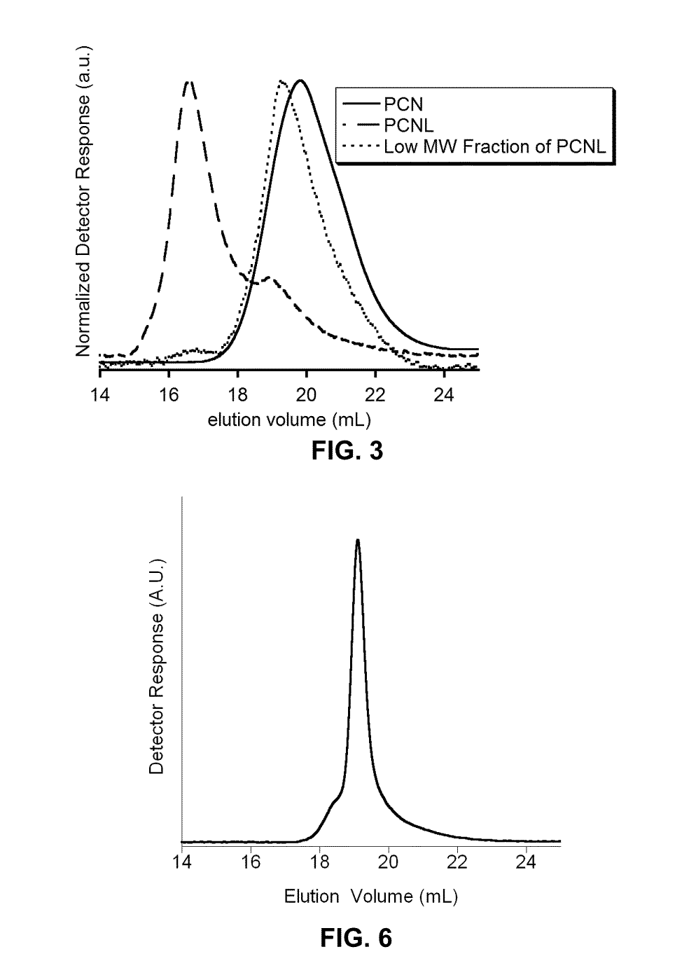

SEC of the graft copolymer of Example 1 revealed a bimodal distribution as shown in FIG. 3. A low molecular weight peak was present at an elution volume of 19 mL which was close to the peak in the SEC trace of the macroinitiator, also plotted. However, solvent-nonsolvent fractionation of the PCNL of Example 1 was performed and the lower molecular weight fraction was analyzed by ¹H NMR and SEC. The SEC trace of the low molecular fraction is also plotted in FIG. 3.

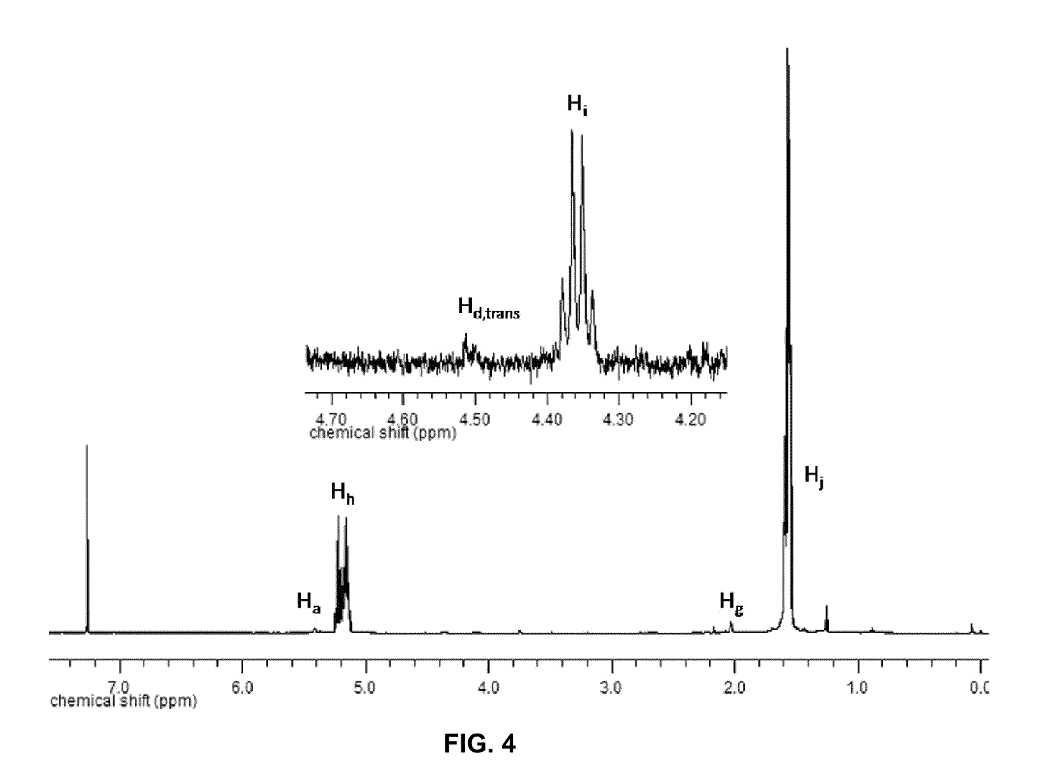

The peak for the low molecular weight fraction of the PCNL of Example 1 appears at an elution volume of 19.5 mL, closer to the unknown peak than the macroinitiator. ¹H NMR of the low molecular weight fraction, shown in FIG. 4, confirmed the material was mostly homopolymer polylactide (˜99 wt. %). Assuming the low molecular weight fraction was 100% homopolymer PLA, the degree of polymerization was found to be 261 from the ratio of the polylactide end group methine proton (Hᵢ) to the methine protons (Hₐ, normalized) in the polymeric repeating unit. This ratio also allowed for the estimation of the DP for the PLA grafts by realizing that the integration for the PLA end group methine proton and the methine protons of the PLA main chain in the PCNL spectrum includes the resonances from the homopolymer PLA. Thus, the DP of the PLA grafts was estimated to be 385 and with approximately 18 wt % homopolymer PLA in the material. The molecular characterization of the graft copolymer and the homopolymer contamination are summarized in Table 2.

TABLE 2
Molecular Characterization of poly(1,5-cyclooctadiene-co-5-norbornene-
2-methanol-graft-lactide) and PLA homopolymer contamination

| | Mₙ | | Mₙ | | | |
|---|---|---|---|---|---|---|
| | (g/mol) | | (g/mol) | | | |
| Material | (NMR) | Wt % | (SEC) | PDI | T_{g} (° C.) | Tₘ (° C.) |
| PCNL | 324,000 | 82 | 153,000 | 2.74 | — | — |
| PCN backbone | 18,600 | 5 | 33,400 | 1.8 | undetectable | 7 |
| PLA grafts | 55,400 | 77 | — | — | 54 | — |
| PLA homopolymer | 37,600 | 18 | 56,700 | 1.4 | — | — |

Differential scanning calorimetry of the graft copolymer of Example 1 (with homopolymer contamination) showed a small melting peak for the backbone at 7° C. much lower than for the backbone without the grafts. The PLA grafts effectively decrease the crystallinity (through perhaps reduction of crystal size) of the backbone and depress the melting temperature. Only a glass transition at 54° C. was observed for polylactide confirming the amorphous nature. The glass transition temperature or the backbone was not observable due to its low relative concentration in the copolymer.

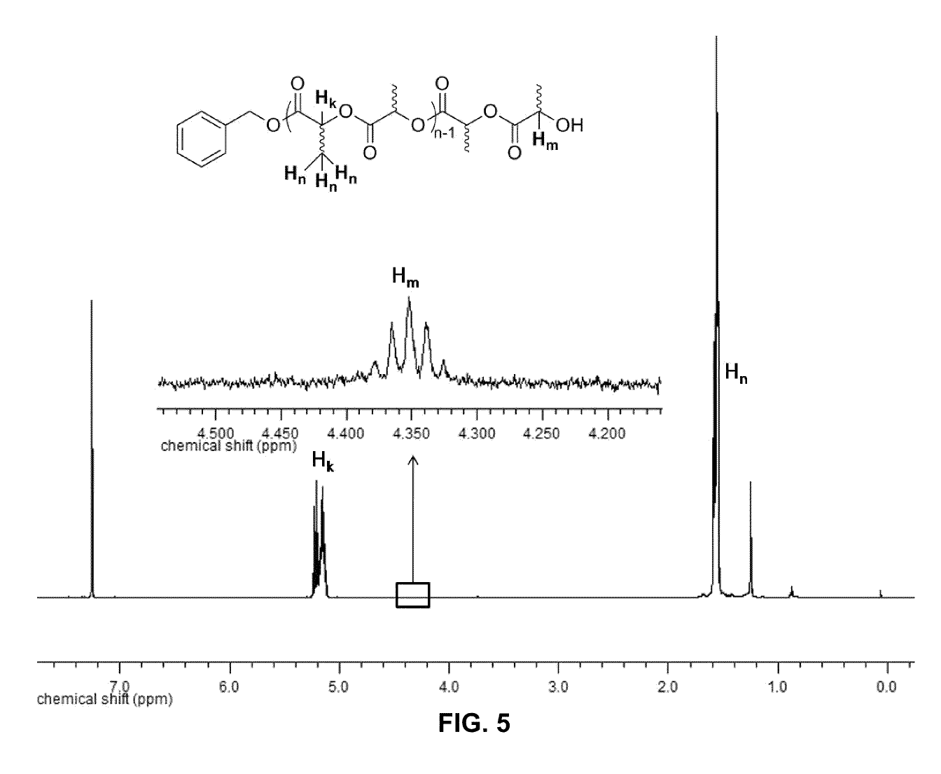

The target degree of polymerization for the polylactide control (Comparative Example 1) was 400 with a target conversion of 80%. Thus, the initial monomer to initiator molar ratio was 500. A conversion below 85% was targeted to avoid significant transesterification and broadening of the molecular weight distribution as the polymerization is an equilibrium reaction. The lactide to catalyst molar ratio was kept the same as for the graft ROP. ¹H NMR of the final crude reaction solution was taken to determine conversion. The conversion of lactide monomer was calculated to be 79%. The isolated yield was 73.4% on a 58 gram scale. The purified and dried material was also characterized by ¹H NMR, SEC and DSC. The full ¹H NMR spectrum of polylactide control of Comparative Example 1 can be seen in FIG. 5 with the key resonances and peak assignments identified. The average DP was determined to be 295 by the ratio of the main chain methine proton (Hₖ, normalized) to the end group methine proton (Hₘ). The molecular weight distribution of the PLA control as determined by SEC is shown in FIG. 6. The PLA homopolymer of Comparative Example 1 was found to have a number-average molecular weight, Mₙ, determined by NMR, of about 42,500 and a Mₙ determined by SEC and PS standards of about 72,140. The polydispersity was fairly low (1.28). A high molecular weight peak is detectable, but relatively small. Differential scanning calorimetry revealed a glass transition temperature at 53.5° C. and no melting endotherm.

### Mechanical Characterization of Example 1

PCNL from Example 1 was compression molded into tensile bars and tested to failure. Compression molding was performed to create Type V tensile specimens conforming to ASTM D638. Five tensile specimens were molded at one time using a Carver press equipped with air and water cooling systems. 2.0 grams of polymer were measured out for each specimen. The steel mold was lightly coated with Teflon release spray before the polymer was added. Polymer was added to the mold which rested on top of a sheet of Teflon and a metal plate while the press was preheated to 130° C. The mold filled with polymer on top of the Teflon and metal plate was placed in the press without compression for 5 minutes. Additional polymer was added to the mold and then allowed to soften for another 5 minutes without any additional pressure. A top sheet of Teflon and another metal plate was placed on the mold with polymer and allowed to heat for 10 minutes. The pressure was then cycled between 0 and 0.3 MPa twenty times to remove any air bubbles. The pressure was increased to 0.6 MPa and held for 5 minutes. With 0.6 MPa of pressure, the mold was water cooled to room temp at 25° C./minute. The specimens were examined for complete mold filling. If not filled, more polymer was added and the procedure was repeated. Specimens were made with not more than two iterations of the procedure. The majority of the flash was removed while the specimens were still in the mold. After removing from the mold, the specimens were conditioned at room temperature and laboratory relative humidity for at least 24 hours before testing. The cross-sectional area and length of the gauge section was measured. SEC was used to confirm the integrity of the polymer after molding. Tensile tests (conforming to ASTM D638) were performed on an Instron 1011. The specimen was clamped by serrated grips and the initial distance between grips was 25.4 mm. Unless otherwise specified, the cross-head extension rate was 10 mm/min. The displacement of the material was determined by elapsed time and cross-head extension rate. Force and displacement were recorded electronically.

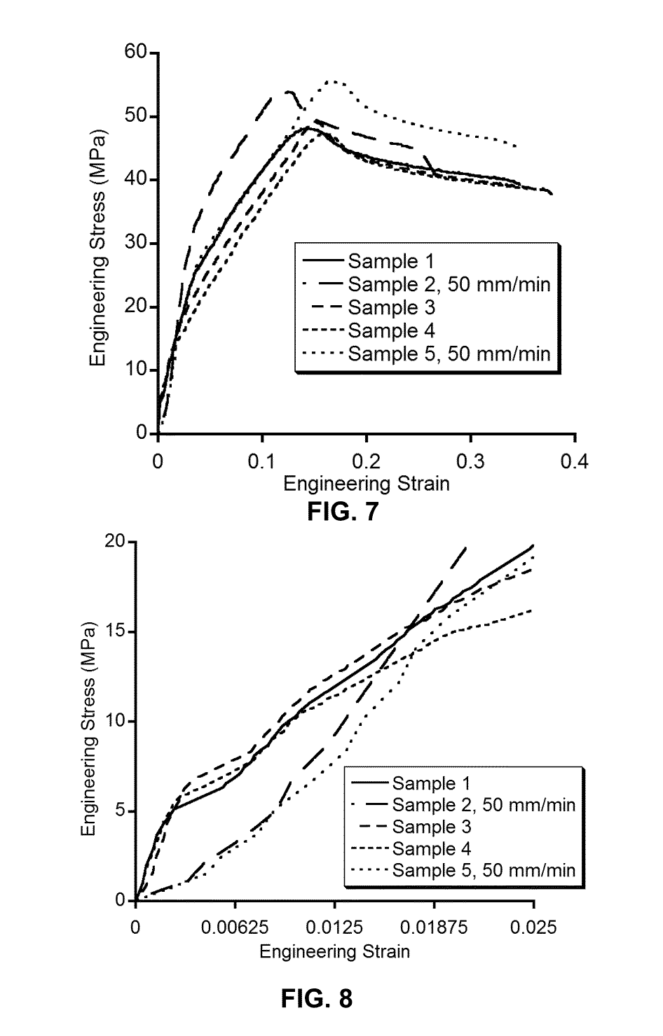

Tensile testing on the five specimens of the PCNL of Example 1 was performed. Three of the samples were tested at a cross-head extension rate of 10 mm/min while two were inadvertently tested at a rate of 50 mm/min. All samples failed within the gauge region and exhibited stress-whitening during the test indicative of a dilatational process. Necking was not visibly apparent. FIG. 7 displays the tensile behavior for all five specimens in terms of engineering stress and strain. All samples exhibited a yield point and some amount of plastic deformation. Additionally, the three samples tested at 10 mm/min appear to behave differently than the two specimens tested at 50 mm/min. The disparity is even more pronounced in the small strain limit shown in FIG. 8. The elastic modulus, stress at break, strain at break and tensile toughness were determined for each sample and summarized in Table 3. The elastic modulus was determined from the slope of a best fit line of the stress-strain curve up to 0.0025 strain and 0.005 strain for the 10 mm/min and the 50 mm/min tests, respectively. Tensile toughness was obtained through numerical integration of the area under the stress-strain curve using the trapezoidal rule.

TABLE 3
Tensile Properties of PNCL

| | | Young' | Stress at | Elongation | Tensile |
|---|---|---|---|---|---|
| | Test rate | Modulus | break | at break | Toughness |
| Sample | (mm/min) | (GPa) | (MPa) | (%) | (MJ/cm³) |
| GCT01134 | 10 | 2.32 | 39.2 | 34.7 | 13.4 |
| Sample 1 | | | | | |
| GCT01134 | 10 | 2.00 | 2.00 | 38.0 | 14.2 |
| Sample 3 | | | | | |
| GCT01134 | 10 | 2.36 | 2.36 | 37.8 | 13.7 |
| Sample 4 | | | | | |
| GCT01134 | 50 | 0.35 | 0.35 | 26.7 | 11.4 |
| Sample 2 | | | | | |
| GCT01134 | 50 | 0.34 | 0.34 | 34.5 | 14.7 |
| Sample 5 | | | | | |
| Avg. of 10 | 10 | 2.2 ± 0.2 | 38.3 ± 0.8 | 36.8 ± 1.9 | 13.8 ± 0.4 |
| mm/min | | | | | |
| Avg. of 50 | 50 | 0.35 ± 0.007 | 42.8 ± 3.0 | 30.6 ± 5.5 | 13.0 ± 2.4 |
| mm/min | | | | | |

Comparing the average values for the samples tested at 10 mm/min to the samples tested at 50 mm/min, a difference in modulus values is observed with the value of the slower rate data being 6 times larger. However, the values for the other properties are within one standard deviation. The qualitative shape of the stress-strain curve, in particular, the appearance of a yield point, would not be influenced by inaccuracy in the strain measurement. The determination of elastic modulus, however, is highly sensitive to the value of strain. Therefore, the large difference in modulus observed between the two extension rates may actually be due to other factors such as slip of the sample from the grips.

Overall, the data obtained at 10 mm/min appears less variable and as such, the average values will be used for comparison to other polymers. Ideally, comparisons should be made between materials with similar molecular weight, such as homopolymer polylactide, made under similar processing history and testing conditions. Table 4 compares the PCNL of Example 1 to the average tensile properties of the PLA of Comparative Example 1 and literature values for high impact polystyrene (HIPS). Relative to the Comparative Example 1, the graft copolymer has a higher modulus, but comparable stress at break. Furthermore, the elongation at break of PCNL of Example 1 is nearly three times larger than that of PLA. In comparison with HIPS, PCNL has a comparable modulus, higher stress at break and higher elongation. These preliminary tensile tests illustrate the enhanced ductility of the graft copolymer relative to the PLA of Comparative Example 1.

TABLE 4
Mechanical Properties of PCNL Compared to poly(D,L-Lactide)
and literature values for high impact polystyrene

| | PCNL | Poly | High-Impact |
|---|---|---|---|
| | 10 mm/min | (D,L-Lactide), | Polystyrene, |
| Parameter | Avg. data | avg. data | literature |
| Young's Modulus (GPa) | 2.2 | 1.3 | 2.24 |
| Stress at break (MPa) | 38.3 | 49.5 | 23 |
| Elongation at break (%) | 36.8 | 14 | 30 |

### Morphological Characterization of Example 1

Small-angle x-ray scattering was performed on PCNL of Example 1 after compression molding. The sample was an irregularly shaped solid piece fragmented from a tensile bar with dimensions of approximately 4 mm×4 mm×1 mm. The sample was placed in a small o-ring and sandwiched between two films of Kapton. Small-angle x-ray scattering was performed using the University of Minnesota Characterization Factility beam lines. The 6 m-apparatus had a sample-to-detector distance of 440 cm, while it was set to 230 cm on a 2 m-apparatus. Copper Kα x-rays (λ=1.542 Å) were generated with a rotating anode. The sample chamber on the 6 m-apparatus was maintained a helium atmosphere while on the 2 m-apparatus, the sample chamber was under vacuum. For all data collected, the exposure time was 5 minutes. For data obtained on the 6 m-line, the sample was held at the test temperature for 5 minutes before data collection. On the 2 m-line, the higher temperature data was obtained after annealing the sample in the chamber at the test temperature for 30 minutes. 2D-scattering patterns were recorded on a Siemens area detector, corrected for detector response, and azimuthally integrated to a 1D plot of intensity versus scattering wavevector, q=4πλ⁻¹ sin(θ/2), where λ and θ are the x-ray wavelength and scattering angle, respectively.

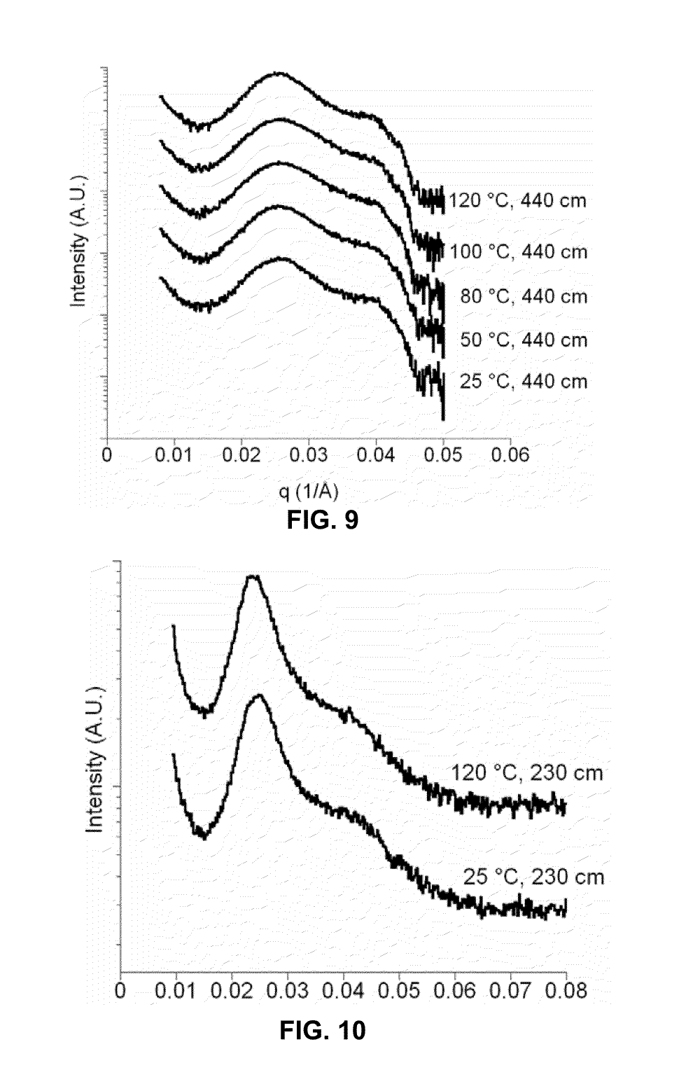

Small-angle x-ray scattering was performed on a sample of the PCNL of Example 1 after compression molding to determine the morphology of the tensile specimens. The sample-to-detector distance was 440 cm. Data was initially collected a 25° C. and then at sequentially higher temperatures as shown in FIG. 9. The scattering profiles have been translated in the y-direction for clarity of viewing. Due to time constraints, the material was not tested above 120° C. At 25° C., a broad primary scattering peak at q*=0.25 Å⁻¹ is observed which corresponds to a domain spacing of 25 nm through the relation d=2πq⁻¹. Additionally, another possible feature is observed at q≅0.04 Å⁻¹. However, it is near the detection limit of the apparatus and may be not be a real feature. Assuming, the second feature is a secondary peak, the scattering profile still would not correspond to a specific well-ordered morphology. As the test temperature is increased to 50° C., a slight increase in intensity is observed; however, the intensity does not continually increase with increasing temperature. In fact, the scattering profiles at 50° C.-120° C. appear nearly identical with respect to shape and relative intensity. It appears that an order-disorder transition is not observed within the temperature range investigated, but the sample was only held at the test temperature for five minutes before data collection. It is possible that the high molecular weight of the sample may require more time at temperature to become disordered.

SAXS was then performed on the 2 m-line at a sample-detector distance of 230 centimeters in order to probe the large scattering wavevector range and determine whether the second order feature was actually present. The same sample from the previous SAXS experiment was used which nullified the “as compression molded” state of the material. Data was collected at 25° C. and at 120° C. For the higher temperature data, the sample was annealed in the apparatus at 120° C. for 30 minutes before data collection in an effort to confirm that the test temperature was below the order-disorder transition. Retrospectively, data should have been collected at the compression molding temperature of 130° C. to provide more meaningful information. The ID scattering profile from the second SAXS experiment is shown in FIG. 10. A vertical translation of the data was used for visual clarity.

The scattering profile obtained at 25° C. at a sample-to-detector distance of 230 cm shows a primary peak at q=0.025 Å⁻¹ as previously observed. The feature seen at q≅0.04 Å⁻¹ in the previous experiment is also observed and does not appear to have been an artifact of the experiment. However, as the test temperature is increased to 120° C., the intensity of the second order feature decreases slightly, while the intensity and location of the primary peak is maintained. Despite the fact the scattering profile does not coincide with the profile of a well-ordered morphology, the presence of the second order peak suggests that the material posses some order and is not a homogeneous mixture. Furthermore, the intensity of the primary peak does not decrease significantly upon heating to 120° C. indicating that the order-disorder transition is most likely above 120° C.

### Example 2

### Materials

ACS reagent grade starting materials and solvents were used as received from commercial suppliers without further purification unless otherwise stated. Benzyl alcohol, 1,5-cyclooctadiene, cis-2-butene-1,4-diol diacetate, 5-norbornene-2-methanol and the 2^{nd} Generation Grubbs' catalyst were purchased from Aldrich. 1,5-cyclooctadiene and cis-2-butene-1,4-diol diacetate were distilled over CaH₂ before use. Degassed dichloromethane was purified by a commercial solvent purification system (MBraun). D,L-lactide (Purac) was recrystallized from toluene, dried under vacuum at room temperature for >24 h and stored under nitrogen.

### Synthesis of poly(1,5-cyclooctadiene-co-5-norbornene-2-methanol)

In the dry box, a catalyst/CTA solution was prepared by adding cis-2-butene-1,4-diol diacetate (freshly distilled, 301 μL, 1.91 mmol)), 2^{nd} generation Grubbs' catalyst (32.4 mg, 38.2 μmol), and dichloromethane (40 mL) to a vial. To a 150 mL pressure vessel were added 5-norbornene-2-methanol (346 μL, 2.86 mmol), 1,5-cyclooctadiene (10.0 g, 92.4 mmol), dichloromethane (30 mL), and a stir bar. 10 mL of the freshly prepared stock solution was added to the pressure vessel to initiate the polymerization at room temperature. After 20 h, the polymerization was quenched by adding excess amount (>20 equivalents) of ethyl vinyl ether. The polymer solution was precipitated from methanol twice to remove catalyst residues and ethyl vinyl ether. The formed solid polymer sample was vacuum dried overnight at room temperature. As similar process was used to synthesize poly(1,5-cyclooctadiene-co-5-norbornene-2-methanol) in Example 1.

### Synthesis of poly(1,5-cyclooctadiene-co-5-norbornene-2-methanol-graft-lactide)

In a dry box, poly(1,5-cyclooctadiene-co-5-norbornene-2-methanol) (0.71 g), dichloromethane (118 mL), D,L-lactide (14.2 g, 98.6 mmol)) and a stir bar were added to a 250 mL single-neck round bottom flask and sealed with a rubber septum. The solids were allowed to dissolve at 25° C. with stirring. A catalyst stock solution was made by dissolving 1,5,7-triazabicyclo[4.4.0]dec-5-ene (TBD) [27.8 mg, 0.199 mmol] in dichloromethane (1 mL) in a vial and sealed with a Teflon septum cap. The round bottom flask was removed from the glove box and immersed in an ice bath. Catalyst solution (0.5 mL) was added to the round bottom flask via the septum. The polymerization was allowed to proceed for 80 min before quenching with benzoic acid (>10 equivalents relative to TBD). The polymer was precipitated into methanol twice before dissolution in dichloromethane (180 mL). Butylated hydroxyl toluene (0.075 g, 0.34 mmol) was added to the polymer solution. The mixture was then poured into a Teflon dish and allowed to dry under ambient pressures and temperatures for 3 days before drying in a vacuum oven at 80-90° C. for four days.

The resulting PCNL graft copolymer of Example 2 has a degree of polymerization of 1,5-cyclooctadiene of about 332, an average of about 10.9 polylactide grafts per chain, and has a weight percentage of polylactide of about 95 wt %. The PCNL graft copolymer of Example 2 is estimated to have a number-average molecular weight, Mₙ, of about 659 kg/mol.

### Comparative Example 2

Homopolymer PLA was synthesized to create a control polymer for comparison. In a dry box, D,L-lactide (15 g, 0.104 mol), dichloromethane (120 mL) and benzyl alcohol (0.0298 g, 0.276 mmol) in dichloromethane (2 mL) were added to a 250 mL round-bottom flask equipped with a stir bar. The flask was sealed with a rubber septum and the lactide was allowed to dissolve. A TBD stock solution was prepared as described above. Outside of the dry box, the flask was immersed in an ice bath and 0.5 mL of the catalyst stock solution was added via the septum. The solution was allowed to stir for 80 min before quenching with excess benzoic acid (>10 equivalents). The polymer was precipitated in methanol twice before drying in a vacuum oven at 80-90° C. for four days.

### General Procedures of Example 2 and Comparative Example 2

Proton nuclear magnetic spectroscopy (¹H NMR) was performed on a Varian Inova 500 at 500 MHz at room temperature. Samples were prepared in CDCl₃ (Cambridge Isotope Laboratories) to concentrations of approximately 20 mg per mL with subsequent filtering through glass wool to remove any dust. Chemical shifts are reported in ppm with respect to the residual proton signals in the solvent assigned to 7.26 ppm.

Size-exclusion chromatography was performed at 35° C. on a Hewlett-Packard 1100 series liquid chromatograph equipped with three Plgel 5 μm Mixed-C columns in series and a Hewlett-Packard 1047A differential refractometer. Chloroform was used as the mobile phase with an elution rate of 1 mL/min. Samples were prepared by dissolving 1 to 2 mg of polymer in chloroform and filtering the solution through a 0.2 μm Teflon filter. Polystyrene standards (Polymer Laboratories) were used for calibration of molecular weights. The polydispersity and number-average molecular weight of the PCNL of Example 2 and the PLA of Comparative Example 2 were calculated using a linear extrapolation of polystyrene calibration data.

Differential scanning calorimetry was performed on a TA DSC Q1000 utilizing an indium standard for temperature calibration. At least 4 mg of sample contained in hermetically sealed aluminum pans were analyzed under N₂ with a 10° C./min heating rate. Thermal transition temperatures were determined from the second heating after annealing above the glass transition or melting point for at least 1 min to erase thermal history.

Small-angle x-ray scattering data was obtained at the Advanced Photon Source at Argonne National Laboratory. The x-ray wavelength was 0.72932 Å with a sample-to-detector-distance of 5.54 meters. Two-dimensional scattering patterns were recorded on a Mar 165 mm diameter CCD detector possessing a resolution of 2048×2048 and azimuthally integrated to a one dimensional plot of intensity versus wavevector, q, where q=4π(λ sin {θ/2})⁻¹ and θ and λ are the scattering angle and x-ray wavelength, respectively.

Samples for transmission electron microscopy (TEM) were microtomed at 25° C. on a Leica EM UC6 Ultramicrotome to a thickness of approximately 70 nm and subsequently stained with OsO₄ vapor for 5 minutes from a 4% aqueous solution. TEM was performed on a JEOL-JEM 1210 microscope with an operating voltage of 120 keV.

Tensile testing of compression molded non-standard dogbone samples (12 mm gage length, 0.5 mm gage thickness, 3 mm gage width) was conducted on a Rheometrics Scientific Minimat Instrument at a cross-head extension rate of 10 mm/min. Reported values are averages and standard deviations of at least four samples.

### Mechanical Characterization of Example 2

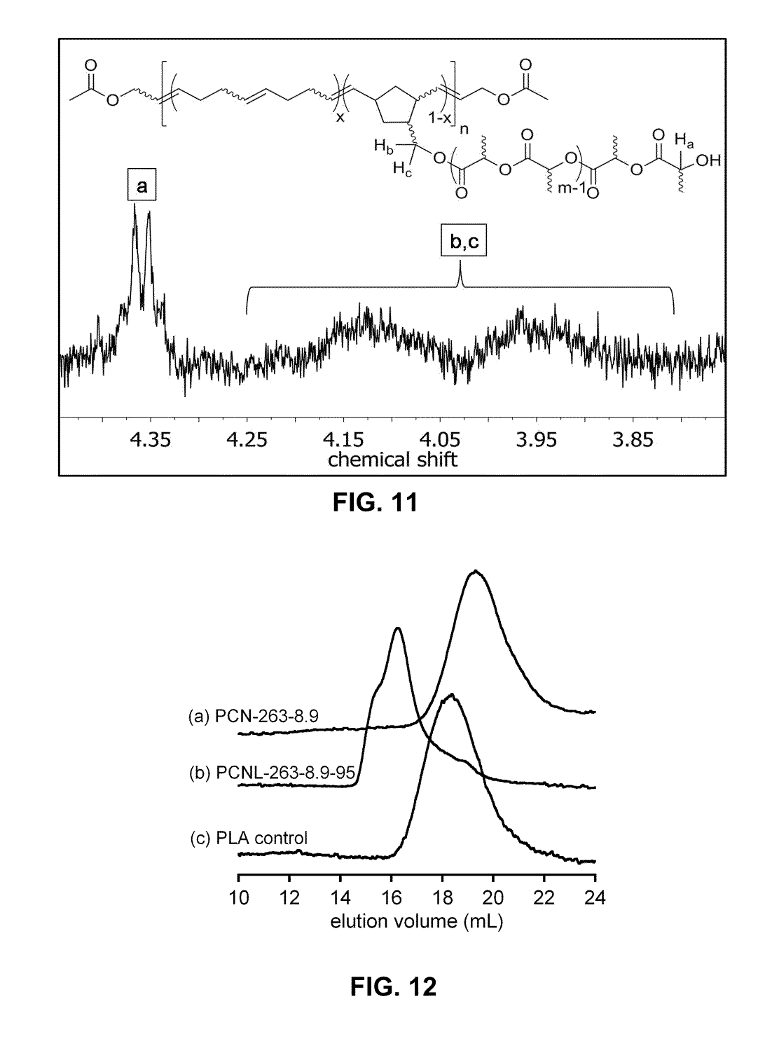

The theoretical molecular weight of each PLA graft is 65 kg/mol. A comparison of the ¹H NMR signals (FIG. 11) from the PLA initiation sites along the PCN backbone (the methylene adjacent to the cyclopentane ring in the backbone) and the terminating end groups (the terminal methine proton of the PLA chains) reveals a slight excess of the terminal methine protons (ca. 18 mol %) suggesting the graft copolymer may contain a small portion of PLA homopolymer from adventitious initiation. Assuming the molar masses of the free and grafted PLA chain are equal, the sample may be calculated as having approximately 19 wt % PLA homopolymer. The calculated number-average molecular weight (Mₙ) of all the PLA chains (free and grafted) in the system is estimated to be 57 kg/mol. Based on the molar mass of the PCN backbone, the estimated PLA arm length and the average number of arms per backbone, the estimated Mₙ for the PCNL of Example 2 is about 659 kg/mol. The PLA homopolymer of Comparative Example 2 has a Mₙ of about 59.0 kg/mol. Size exclusion chromatography (SEC) data for the macroinitiator (shown in FIG. 12a), PCN, shows a relatively symmetric, monomodal peak (Mₙ=55.6 kg mol⁻¹, PDI=1.69, PS standards). The PCNL polymer of Example 2 (FIG. 12b) elutes at a smaller retention volume than the macroinitiator indicating successful grafting of PLA from the macroinitiator, but exhibits both high and low molecular weight shoulders (Mₙ=305 kg mol⁻¹, PDI=2.34, PS standards). Comparison of the SEC traces for the macroinitiator, graft copolymer and PLA control of Comparison Example 2 (FIG. 12c; Mₙ=94 kg mol⁻¹, PDI=1.88, PS standards) suggests that the low molecular weight shoulder may arise from unfunctionalized backbone chains, PLA homopolymer, or both.

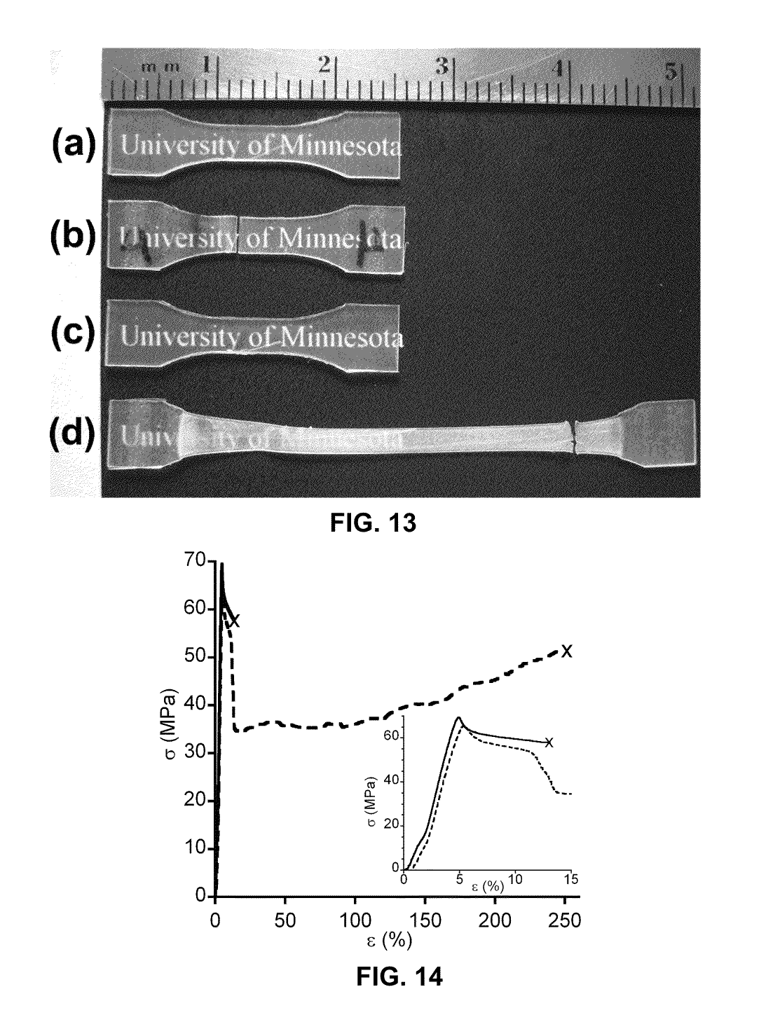

The mechanical behavior of the PCNL graft copolymer of Example 2 was characterized by tensile testing of compression-molded samples. Mechanical properties of the PCNL graft copolymer were compared to those of the PLA control of Comparative Example 2. FIG. 13a shows the PLA control of Comparative Example 2 before being subjected to tensile testing, while FIG. 13b shows the PLA control after tensile testing. FIGS. 13a and 13b show that the PLA control failed catastrophically after a relatively small amount of deformation without neck formation or stress whitening, characteristic of a brittle material. FIG. 13c shows the PCNL graft copolymer of Example 2 before tensile testing, while FIG. 13d shows the PCNL graft copolymer after tensile testing. As can be seen in FIG. 13d, the PCNL graft copolymer of Example 2 exhibited neck formation, stress whitening, cold drawing and extensive elongation. Representative engineering stress-strain curves for both materials are shown in FIG. 14. In FIG. 14, the dashed line represents the PCNL graft copolymer of Example 2 while the solid line represents the control PLA of Comparative Example 2. The “x” for each curve represents the failure point. On average, the PLA control of Comparative Example 2 elongated to 13±4% before failure, similar to a reported literature value for amorphous poly(L-lactide). In contrast, the PCNL graft copolymer of Example 2 exhibited an average ultimate elongation of 238±43%, a 1700% increase relative to the PLA of Comparative Example 2. Furthermore, the average tensile modulus, E, and yield strength, σ_{y}, of the PCNL graft copolymer (E=1.86±0.09 GPa, σ_{y}=64.8±2.0 MPa) were only slightly lower than the PLA control (E=2.03±0.07 GPa, σ_{y}=67.9±1.3 MPa). Overall, the tensile toughness, determined from integration of the engineering stress-strain curve, of the PCNL graft copolymer of Example 2 was 14 times larger than the PLA control sample (95.2±22.9 MJ/m³ vs. 6.8±2.41 MJ/m³).

The whitening of the gage region observed during tensile testing of the PCNL graft copolymer of Example 2 suggests that microscopic dilatation has occurred. Additionally, macroscopic neck formation is typically attributed to a shear yielding mechanism. Similar macroscopic observations were made by Jansen et al., J. Macromolecules, 2001, 34, 3998-4006, during tensile testing of a rubber-modified poly(methyl methacrylate) blend, with rubber particle sizes of 20 nm. Utilizing in-situ SAXS during tensile testing, the authors obtained evidence to support a deformation mechanism of rubber phase cavitation followed by shear yielding of the matrix. Thus, we speculate that the stress whitening observed in the PCNL graft copolymer also results from cavitation of the nanoscopic rubber domains. Cavitation of the rubber phase would alleviate the expected local triaxial stress state around the rubber domains, alter the stress state in the matrix, and thus, promote shear yielding. Therefore, we suggest that in uniaxial tension, cavitation of the rubber domains followed by shear yielding of the matrix are the additional stress dissipation mechanisms which led to the increase of the tensile toughness of the PCNL graft copolymer of Example 2 relative to that of the control PLA of Comparative Example 2.

### Morphological Characterization of Example 2

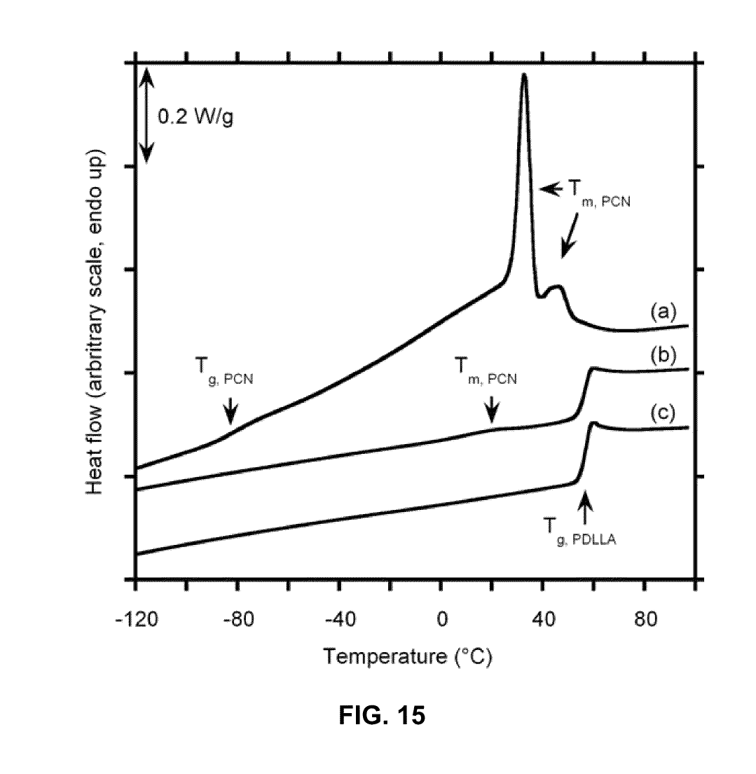

The morphology adopted by the PCNL polymer of Example 2 is important based upon the well-established impact of microphase separation on ductility in rubbery-glassy composites. The PCNL graft copolymer of Example 2 presumably lies near the order-disorder phase boundary based on the large compositional asymmetry (95 wt % PLA). However, the anticipated high degree of immiscibility between PLA and the aliphatic PCN backbone combined with an effectively large conformational asymmetry between the PLA grafts and the PCN backbone both favor microphase separation. Differential scanning calorimetry (DSC) of the PCN backbone (FIG. 15a) revealed a T_{g} of about −81° C. and a broad set of endothermic melting transition between about −10° C. and about 50° C. due to the semi-crystalline nature of poly(1,5-cyclooctadiene). After grafting of PLA onto the macroinitiator, only a very weak melting transition was observed (centered at about 20° C.) (FIG. 15b). The PLA T_{g} in the PCNL graft copolymer of Example 2 was apparent at 57° C. (FIG. 15c), a value nearly identical to the PLA control sample and consistent with microphase separation. The T_{g} of the rubbery PCN backbone of the PCNL graft copolymer of Example 2 was not observable.

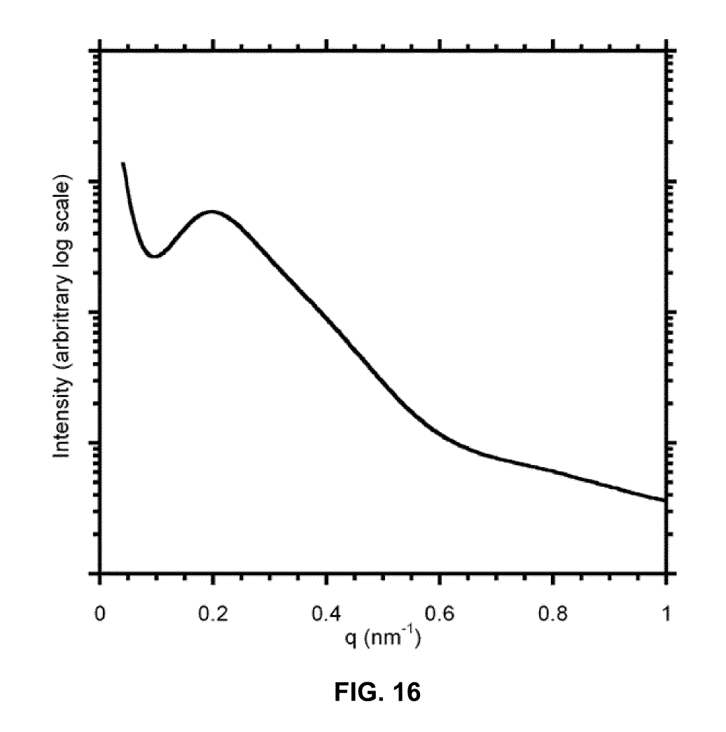

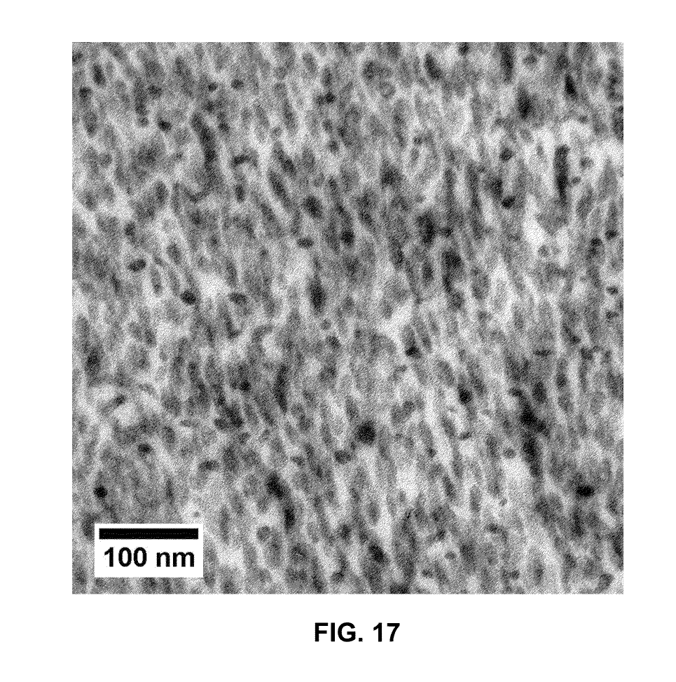

Small-angle x-ray scattering (SAXS) of the PCNL graft copolymer of Example 2 showed a single primary peak in the one-dimensional profile of intensity versus spatial frequency (FIG. 16), suggesting a microphase-separated, but disordered structure with a principal domain spacing of approximately 32 nm. Transmission electron microscopy (TEM) of thin sections of the PCNL graft copolymer (stained with OSO₄) revealed a microphase-separated morphology consisting of spheroidal domains rich in poly(1,5-cyclooctadiene), with the double bonds in the PCN backbone being stained by the OsO₄, surrounded by a matrix of PLA (FIG. 17). Although the TEM image is a two dimensional projection, the approximate domain spacing (˜30 nm) supports the results from SAXS. Both the PCNL graft copolymer of Example 2 and the PLA control of Comparative Example 2 were optically transparent (FIGS. 13a and 13c).

In summary, a rubber-toughened PLA hybrid material containing only 5 wt % rubber was synthesized using a grafting-from approach. Despite the large compositional asymmetry, a microphase-separated morphology was observed by SAXS and TEM analysis. The large improvement in tensile ductility (without a major loss of strength or rigidity) observed for the graft copolymer relative to PLA demonstrates the potential for an optically transparent and impact-resistant polylactide based material. We are currently exploring the molecular parameters needed to achieve the improved properties in these materials and the influence on impact performance.

### Example 3

In another experiment, with the aim of rubber toughening PLA, graft copolymers were synthesized via a two-step reaction scheme. Rubbery macroinitiators were produced from the G2 catalyzed ROMP copolymerization of 1,5-cyclooctadiene (COD) and 5-norbornene-2-methanol. Cis-1,4-diacetoxy-2-butene was used as a chain transfer agent (CTA) to control molecular weight. However, an isomer of COD, vinyl cyclohexene, acted as an adventitious CTA limiting the maximum possible molecular weight. Molecular weights up to about 55 kg/mol were obtained with monomodal distributions and PDIs ranging from about 1.7 to about 3.2. In general, good agreement was observed by ¹H NMR between the feed composition and copolymer composition. Overall, the copolymer composition ranged from about 1 to about 13 mol % norbornene-2-methanol. A single T_{g} was observed for the macroinitiators ranging from about −87° C. to about −75° C. indicative of a statistical comonomer distribution. The copolymers were semi-crystalline with melting transitions ranging from about 17° C. to about 47° C. with about 18% to about 69% crystallinity (calculated using the enthalpy of fusion for trans-1,4-polybutadiene).

The rubbery macroinitiators were used to initiate the TBD-catalyzed ROP of DL-lactide to yield graft copolymers with compositions ranging from about 80 to about 99 wt % PLA, with the majority of samples containing about 95 wt % PLA. All polymerizations were run to high conversion of monomer (98-99%). However, by ¹H NMR the observed PLA Mₙ, the molecular weight of a single PLA graft, was lower than expected for samples where the theoretical PLA Mₙ exceeded approximately 75 kg/mol, possibly due to adventitious initiation or limitations of end-group analysis. The molecular weight distributions for graft copolymers containing up to about 89 wt % PLA were monomodal with PDIs ranging from 1.5 to 2.2. For these polymers, the expected (and observed) PLA Mₙ was less than 12 kg/mol. For graft copolymers containing about 95 wt % PLA, both monomodal and multimodal molecular weight distributions, with PDI's ranging from about 1.4 to about 5.2 were observed. Generally, the graft copolymers containing lower PLA Mₙ possessed narrower, monomodal molecular weight distributions. Only bimodal and multimodal distributions were observed for the 99 wt % PLA graft copolymers with PDIs from about 2.4 to about 4.7. The expected PLA Mₙ for these polymers ranged from about 85 to about 340 kg/mol. A time-resolved experiment revealed that the adventitious initiation and polymerization of homopolymer PLA was occurring during the polymerization of a 99 wt % PLA graft copolymer and responsible for the bimodal distribution. Thus, the graft copolymers containing about 99 wt % PLA were believed to be blends of graft copolymer and homopolymer PLA. For all the example compositions, only the T_{g} of PLA was observed, ranging from about 48° C. to about 58° C., without an apparent correlation to Mₙ or composition. A melting peak for the backbone was observed between about −21° C. and about 32° C.; however, the crystallinity of the rubbery backbone did not exceed 4%.

Tensile testing was performed on compression molded samples. Both brittle behavior and ductile behavior was observed. Brittle samples were macroscopically observed to stress whiten while ductile samples formed a neck and underwent cold drawing of the gage section. In general, modulus and yield strength increased with increasing PLA content. However, there was no correlation between average tensile toughness (TT) and either composition or total backbone molecular weight. All 99 wt % PLA polymers exhibited brittle behavior which may have been due to the large amounts of homopolymer contamination.

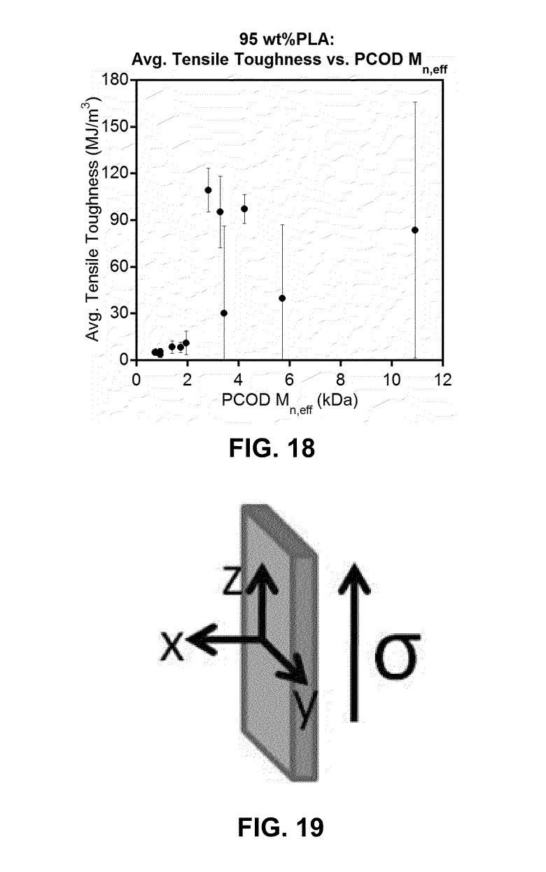

Considering only the 95 wt % PLA polymers, a brittle-to-ductile transition was observed by plotting TT as a function of backbone molecular weight between graft points or M_{n,eff}. FIG. 18 is a plot of the average TT as a function of backbone molecular weight between graft points or M_{n,eff} for various 95 wt % PLA polymers examples. As shown in FIG. 18, graft copolymers possessing an M_{n,eff}≦about 2 kg/mol exhibited relatively brittle behavior regardless of composition, while those with an M_{n,eff}>about 3 kg/mol exhibited relatively ductile behavior manifested by necking and cold drawing. The large standard deviations determined for the ductile materials highlights a sensitivity of the polymers to defects such as dust. If a sample failed unexpectedly, but a defect was not visually observed (with the naked eye) as the cause for failure, the data was still included in the analysis. It is possible that inspection of the fracture surfaces of the samples by optical or scanning electron microscopy would reveal a defect that would preclude the inclusion of the data in the statistical analysis.

FIG. 19 is a schematic of a tensile bar defining the conventions used in both SAXS and TEM analysis in Example 3. As shown, the tensile direction was approximately parallel to the z-axis.

Room temperature small-angle x-ray scattering (SAXS) analysis was performed on graft copolymers containing 89-99 wt % PLA at the Advanced Photon Source at Argonne National lab on undeformed and deformed tensile bars in the yz-plane, as illustrated in FIG. 19. Analysis of the undeformed tensile bars revealed primary scattering peaks with occasional broad secondary peaks for the about 89-95 wt % PLA polymers resulting in domain spacings from about 14 to about 44 nm. The 1D-scattering profile of two samples containing 89 wt % PLA indicated a possible cylindrical morphology. The scattering profiles of the graft copolymers containing 95 wt % PLA could not be assigned to any of the equilibrium morphologies in spite of the presence of secondary scattering peaks. SAXS of the 99 wt % PLA graft copolymers resulted in a single, poorly defined peak which yielded domain spacings ranging from about 25 to about 36 nm.

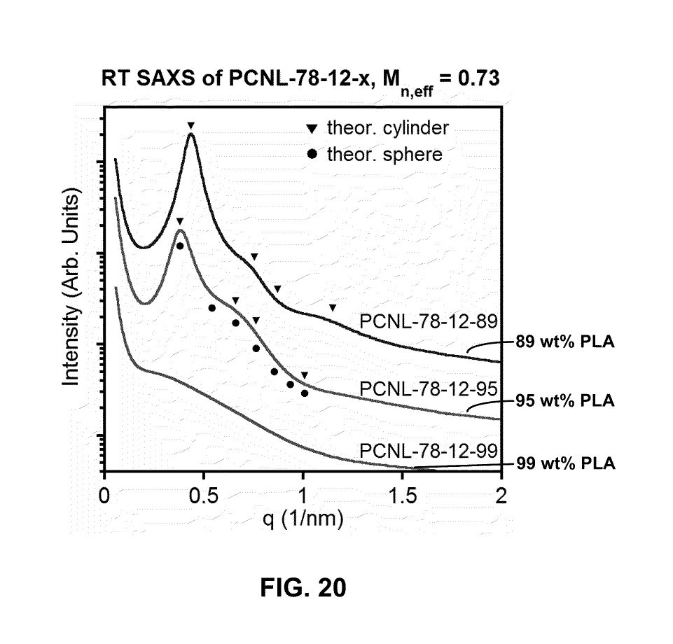

FIG. 20 illustrates the general characteristics of the 1D-scattering profiles for the various examples compositions (89, 95 and 99 wt % PLA) with three graft copolymers synthesized from the same macroinitiator.

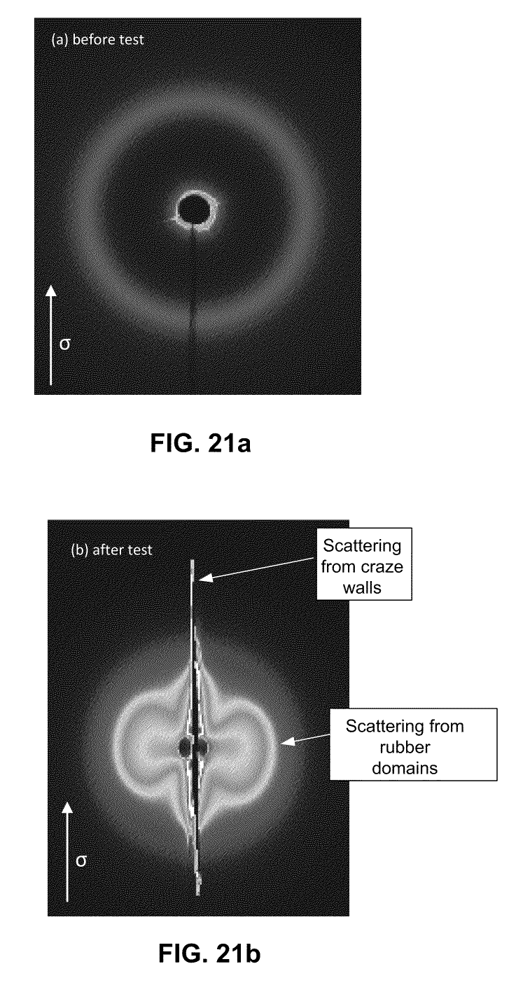

Room temperature SAXS on the gage region of deformed tensile bars after failure was also performed. The orientation of the samples during SAXS was maintained the same for each analysis. For brittle samples, the 2D-SAXS pattern is anisotropic with features characteristic of scattering from crazes. FIGS. 21a and 21b are the 2D SAXS patterns for a brittle 95 wt % graft copolymer example before deformation and after deformation, respectively. The tensile direction, σ, was as indicated in FIGS. 21a and 21b.

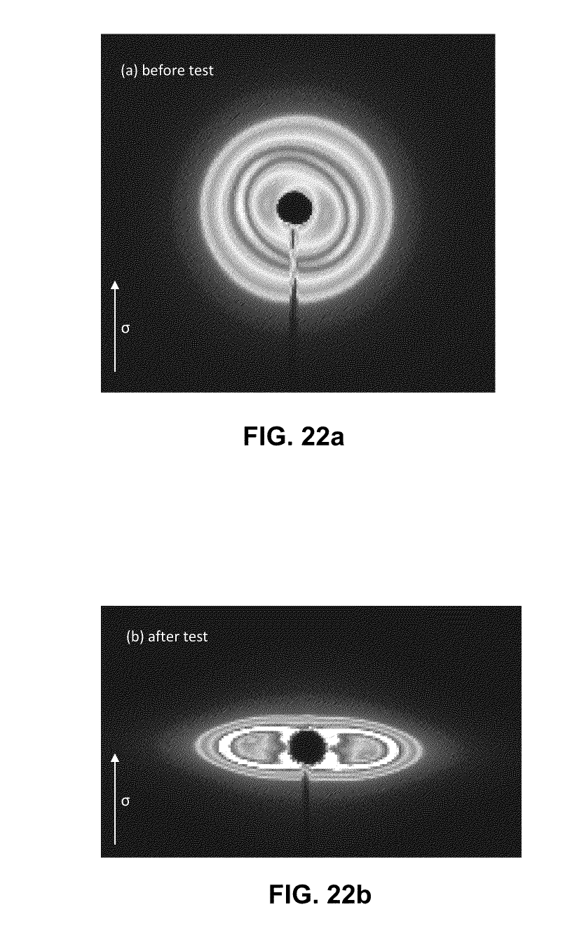

FIGS. 22a and 22b are the 2D SAXS patterns for a ductile 95 wt % graft copolymer example before deformation and after deformation, respectively. The tensile direction, σ, was as indicated in FIGS. 22a and 22b. The 2D-SAXS pattern for cold-drawn ductile samples was also anisotropic, but indicated an elongation and alignment of the rubber domains in the tensile direction with little evidence indicative of crazing (as shown in FIGS. 22a and 22b). However, the SAXS data was not obtained during the tensile test, but after the failure of the sample; thus, craze initiation prior to cold drawing cannot be ruled out as the shear yielding of the samples may have altered any pre-existing craze morphology. For the same reasons, the presence of rubber domain cavitation cannot be determined. The integration of the 2D patterns was not performed due to the complexity introduced by the anisotropy.

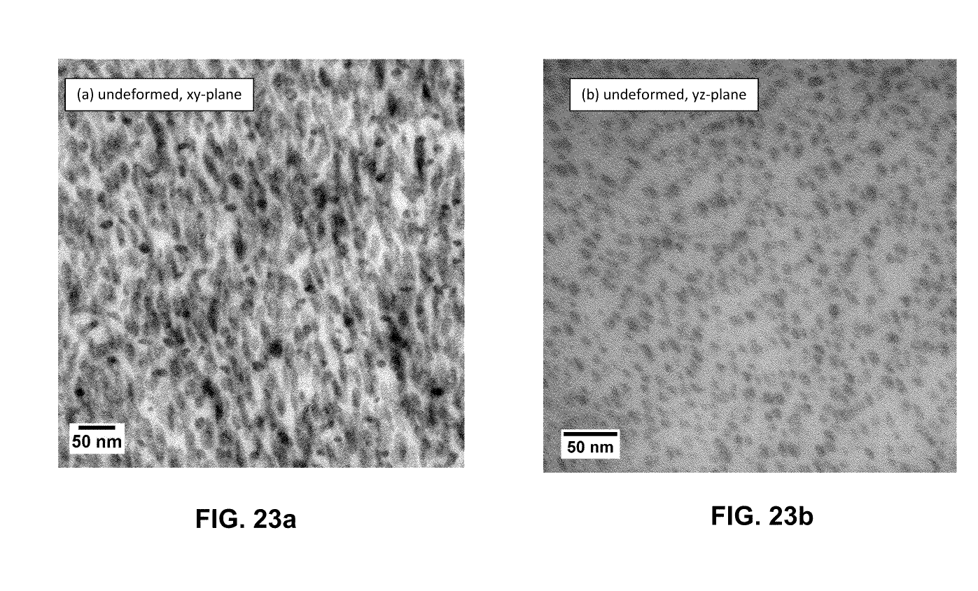

Transmission electron microscopy (TEM) was performed on one sample, (referred to as “PCNL-332-10.9-95”), a ductile 95 wt % PLA graft copolymer example, which was substantially the same or similar to that in Example 2. FIGS. 23a and 23b are TEM micrographs of the ductile 95 wt % PLA graft copolymer sample in the xy-plane and yz-plane, respectively. Examination of an undeformed tensile bar revealed a microphase separated morphology consisting of poorly-ordered, round domains of rubber in a matrix of PLA. However, comparison of the xy-plane and the yz-plane shown in FIGS. 23a and 23b, respectively, suggests a possible anisotropy in the morphology. The domains in the xy-plane (FIG. 23a) appear slightly more elongated with different packing than the domains in the yz-plane (FIG. 23b). SAXS in the xy-plane could be used to confirm this hypothesis.

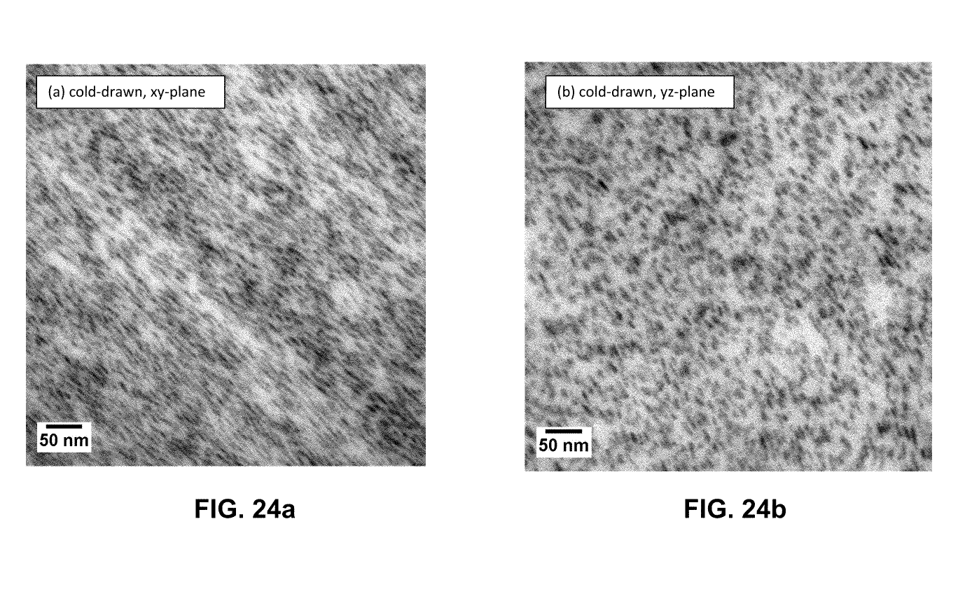

FIGS. 24a and 24b are TEM micrographs of the cold-drawn gage region of the ductile 95 wt % PLA graft copolymer example (PCNL-332-10.9-95 sample) in the xy-plane and yz-plane, respectively. As shown, TEM of a cold-drawn sample displayed elongated rubber domains in both the xy and yz-planes. Further, no evidence of crazing or cavitation was observed.

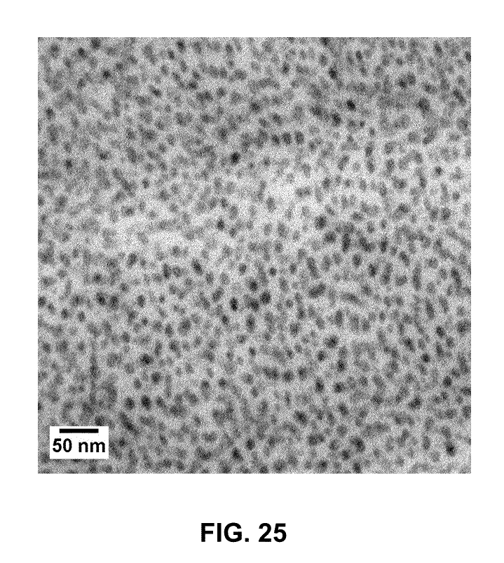

Finally, the yz-plane of a stress-whitened region of a partially deformed sample was examined for evidence of cavitation or crazing (FIG. 8). FIG. 25 is a TEM micrograph of the stress-whitened (not cold drawn) region of the ductile 95 wt % PLA graft copolymer example (PCNL-332-10.9-95 sample) in the yz-plane. The particular region investigated had not undergone cold drawing. However, the morphology of this sample seemed similar to the undeformed case and no evidence for crazing or cavitation was found.

Various examples of the disclosure have been described. These and other examples are within the scope of the following claims.

1. A polylactide copolymer comprising a graft copolymer of a hydrophobic backbone polymer having a plurality of pendant hydroxyl groups and lactide.

2. The polylactide copolymer of claim 1, wherein the hydrophobic backbone polymer having a plurality of pendant hydroxyl groups comprises a poly(1,5-cyclooctadiene-co-5-norbornene-2-methanol) copolymer.

3. The polylactide copolymer of claim 1, wherein the hydrophobic backbone polymer having a plurality of pendant hydroxyl groups comprises at least one of hydroxylated polyisoprene backbone, a hydroxylated polybutadiene backbone, a hydroxylated polyethylene backbone, a hydroxylated polypropylene backbone, or a hydroxylated polyisobutylene backbone.

4. The polylactide copolymer of claim 1, wherein the lactide comprises at least one of D,L-lactide, meso-lactide, L-lactide, or D-lactide.

5. The polylactide copolymer of claim 1, wherein the composition of the graft copolymer comprises between about 65 wt % and about 99 wt % lactide and between about 1 wt % and about 35 wt % of the hydrophobic backbone polymer.

6. The polylactide copolymer of claim 1, composition of the graft copolymer is between about 80 wt % and about 99 wt % lactide and between about 1 wt % and about 20 wt % of the hydrophobic backbone polymer.

7. The polyactide copolymer of claim 1, further comprising a graft copolymer of a derivative of the hydrophobic backbone polymer having a plurality of pendant hydroxyl groups and lactide.

8. The polyactide copolymer of claim 7, wherein the derivative of the hydrophobic backbone polymer having a plurality of pendant hydroxyl groups comprises an ester derivative of the hydrophobic backbone polymer having a plurality of pendant hydroxyl groups.

9. A polylactide copolymer comprising a graft copolymer of a poly(1,5-cyclooctadiene-co-5-norbornene-2-methanol) copolymer and lactide.

10. The polylactide copolymer of claim 9, wherein the lactide comprises at least one of D,L-lactide, meso-lactide, L-lactide, or D-lactide.

11. The polylactide copolymer of claim 9, wherein the composition of the graft copolymer is between about 65 wt % and about 99 wt % lactide and between about 1 wt % and about 35 wt % poly(1,5-cyclooctadiene-co-5-norbornene-2-methanol) copolymer.

12. The polylactide copolymer of claim 9, wherein the composition of the graft copolymer is between about 80 wt % and about 99 wt % lactide and between about 1 wt % and about 20 wt % poly(1,5-cyclooctadiene-co-5-norbornene-2-methanol) copolymer.

13. The polylactide copolymer of claim 9, wherein the composition of the graft copolymer is between about 90 wt % and about 97 wt % lactide and between about 3 wt % and about 7 wt % poly(1,5-cyclooctadiene-co-5-norbornene-2-methanol) copolymer

14. The polylactide copolymer of claim 9, wherein the graft copolymer comprises between about 4 and about 40 grafts of the lactide per chain.

15. The polylactide copolymer of claim 9, wherein the graft copolymer has a number-average molecular weight of between about 300 kg per mole and about 1000 kg per mole.

16. The polylactide copolymer of claim 9, wherein the graft copolymer has a polydispersity index of between about 2 and about 2.8.

17. The polylactide copolymer of claim 9, wherein grafts of lactide are statistically distributed through the graft copolymer.

18. The polylactide copolymer of claim 9, wherein grafts of lactide of the graft copolymer have an average molecular weight of about 65 kg per mole.

19. The polyactide copolymer of claim 9, further comprising a graft copolymer of a derivative of a hydrophobic backbone polymer having a plurality of pendant hydroxyl groups and lactide.

20. The polyactide copolymer of claim 19, wherein the derivative of the hydrophobic backbone polymer having a plurality of pendant hydroxyl groups comprises an ester derivative of the hydrophobic backbone polymer having a plurality of pendant hydroxyl groups.

21. A method of preparing a toughened polylactide, the method comprising:
forming a hydrophobic backbone copolymer having a plurality of pendant hydroxyl groups; and
forming a polylactide graft copolymer by reacting the hydrophobic backbone copolymer having a plurality of pendant hydroxyl groups with lactide, wherein polymerized lactide stems from at least one of the plurality of pendant hydroxyl groups.

22. The method of claim 21, wherein forming the hydrophobic backbone copolymer having the plurality of pendant hydroxyl groups comprises forming poly(1,5-cyclooctadiene-co-5-norbornene-2-menthanol).

23. The method of claim 22, wherein forming poly(1,5-cyclooctadiene-co-5-norbornene-2-menthanol) comprises reacting 1,5-cyclooctadiene and 5-norbornene-2-methanol in the presence of a 2^{nd} generation Grubbs' catalyst and cis-1,4-diacetoxy-2-butene as a chain transfer agent.

24. The method of claim 21, wherein forming the hydrophobic backbone copolymer having the plurality of pendant hydroxyl groups comprises forming a hydroxylated polyisoprene copolymer.

25. The method according to claim 21, wherein the lactide comprises at least one of D,L-lactide, meso-lactide, L-lactide, or D-lactide.

26. A method of preparing a toughened polylactide, the method comprising:
forming poly(1,5-cyclooctadiene-co-5-norbornene-2-menthanol) by reacting 1,5-cyclooctadiene and 5-norbornene-2-methanol in the presence of a 2^{nd} generation Grubbs' catalyst and cis-1,4-diacetoxy-2-butene as a chain transfer agent; and
forming poly(1,5-cyclooctadiene-co-5-norbornene-2-methanol-graft-lactide) by reacting the poly(1,5-cyclooctadiene-co-5-norbornene-2-menthanol) as a macroinitiator with lactide in the presence of tin 2-ethylhexanoate and toluene or in the presence of 1,5,7-triazabicyclo[4.4.0]dec-5-ene and dichloromethane.

27. The method according to claim 26, wherein the lactide comprises at least one of D,L-lactide, meso-lactide, L-lactide, or D-lactide.

28. The method according to claim 26, wherein the target degree of polymerization for the 1,5-cyclooctadiene in the step of forming the poly(1,5-cyclooctadiene-co-5-norbornene-2-menthanol) is between about 100 and about 500.

29. The method according to claim 26, wherein the step of forming the poly(1,5-cyclooctadiene-co-5-norbornene-2-menthanol) comprises using between about 0.3 mol % and about 30 mol % 5-norbornene-2-methanol in the feed.

30. The method according to claim 26, wherein the step of forming the poly(1,5-cyclooctadiene-co-5-norbornene-2-menthanol) comprises having a ratio of the 1,5-cyclooctadiene to the 2^{nd} Generation Grubbs' catalyst of between about 2000:1 and about 20000:1.

31. The method according to claim 26, wherein the target degree of polymerization for the lactide in the step of forming the poly(1,5-cyclooctadiene-co-5-norbornene-2-methanol-graft-lactide) is between about 40 and about 700.

32. The method according to claim 26, wherein the target degree of polymerization for the lactide in the step of forming the poly(1,5-cyclooctadiene-co-5-norbornene-2-methanol-graft-lactide) is between about 95 and about 450.

33. The method according to claim 26, wherein the step of forming the poly(1,5-cyclooctadiene-co-5-norbornene-2-menthanol) results in between about 1 unit and about 40 units of 5-norbornene-2-methanol per polymer chain.

34. The method according to claim 26, wherein the target degree of polymerization for the lactide in the step of forming poly(1,5-cyclooctadiene-co-5-norbornene-2-methanol-graft-lactide) is between 70 and 600 with a lactide to Sn(Oct)₂ molar ratio of about 5000:1 or lactide to TBD molar ratio of 1000:1.

35. The method according to claim 26, wherein the composition of the monomer feed for the step of forming poly(1,5-cyclooctadiene-co-5-norbornene-2-methanol-graft-lactide) is about 80-99 wt % lactide and about 1-20 wt % poly(1,5-cyclooctadiene-co-5-norbornene-2-menthanol).
